(19) United States
(12) Patent Application Publication
(10) Pub. No.: US 2024/0266754 A1
(43) Pub. Date: Aug. 8, 2024

(54) ARRAY ANTENNA AND ANTENNA ELEMENT

(71) Applicant: NIHON DENGYO KOSAKU CO., LTD., Tokyo (JP)

(72) Inventor: Uichiro AZUMA, Tokyo (JP)

(73) Assignee: NIHON DENGYO KOSAKU CO., LTD., Tokyo (JP)

(21) Appl. No.: 18/565,506

(22) PCT Filed: Nov. 25, 2021
(86) PCT No.: PCT/JP2021/043191

§ 371 Date: Nov. 29, 2023

(51) Int. Cl. H01Q 21/08; H01Q 3/26; H01Q 5/378

(52) U.S. Cl. CPC H01Q 21/08; H01Q 3/26; H01Q 5/378

(57) ABSTRACT

An array antenna includes: a first antenna element and a second antenna element configured to transmit and receive radio waves; and a feeding line configured to feed the first antenna element and the second antenna element in series, wherein the first antenna element and the second antenna element respectively have a feeding element fed from the feeding line and a parasitic element part having a parasitic element, the parasitic element part being provided to face the feeding element, and a number of the parasitic element of the parasitic element part in the first antenna element is different from a number of the parasitic element of the parasitic element part in the second antenna element.

### TECHNICAL FIELD

This invention relates to an array antenna and an antenna element.

### BACKGROUND ART

With the development of mobile communications, radio waves with a frequency band higher than sub-millimeter wave band having short wavelength have come to be used.

Microstrip antennas (MSA), which are fed by microstrip lines (MSL) as a feeding line, can be manufactured to be small, lightweight, and inexpensive by processing printed circuit boards, and array antennas with various directivity can be designed by arraying them.

Non-patent document 1 describes a linear array antenna, which is applied to the 28.0 GHz sub-millimeter wave band, uses a patch element with an uncharged element, and is powered by a series feeding method.

### CITATION LIST

### Non-Patent Literature

[Non-Patent Document] Pilip Ayiku Dzagbletey, Kwang-Seon Kim, Woo-Jin Byun, Young-Bae Jung, “Stacked microstorip linear array with highly suppressed side-lobe levels and wide bandwidth,” IET Microw. Antennas Propag. 2017, Vol. 11, Iss 1, pp. 17-22.

### SUMMARY OF INVENTION

### Technical Problem

By the way, feeding methods for each arrayed antenna include: a parallel feeding method that uses feeding lines branched in parallel as many as the number of antennas, and a series feeding method that uses a single feeding line. In the frequency band higher than sub-millimeter wave band, the series feeding method is often used because it allows smaller array spacing. However, array antennas using the series feeding method have a narrow fractional bandwidth of the used frequency with only a few percent, thus wider bandwidth is required for use in high-speed communications such as 5G and for suppressing characteristic degradation due to manufacturing errors.

The purpose of the present invention is to provide an array antenna with a series feeding method and having a wider bandwidth and the like.

### Solution to Problem

The array antenna to which the present invention is applied includes: a first antenna element and a second antenna element configured to transmit and receive radio waves; and a feeding line configured to feed the first antenna element and the second antenna element in series, wherein the first antenna element and the second antenna element respectively have a feeding element fed from the feeding line and a parasitic element part having a parasitic element, the parasitic element part being provided to face the feeding element, and a number of the parasitic element of the parasitic element part in the first antenna element is different from a number of the parasitic element of the parasitic element part in the second antenna element.

In such an array antenna, the array antenna includes: a substrate made of a dielectric material, on whose surface side the parasitic element part in the first antenna element and the parasitic element part of the second antenna element are provided, wherein the feeding element in the first antenna element and the feeding element in the second antenna element are provided on a back surface side of the substrate or are provided to be in contact with the back surface side of the substrate. Furthermore, the substrate has a constant thickness.

In such an array antenna, at least any one of the parasitic element part in the first antenna element and the parasitic element part in the second antenna element comprises plural parasitic elements including a pair of parasitic elements, the pair of the parasitic elements being separately provided with a H-plane in a center of the feeding element as a border and being excited in-phase in a basic mode. Furthermore, the plural parasitic elements include a parasitic element that is not separately provided with the H-plane as a border.

Furthermore, in such an array antenna, a volume between the plural parasitic elements and the feeding element is larger than a volume in a case between one parasitic element and the feeding element.

In such an array antenna, the parasitic element part in the first antenna element and the parasitic element part in the second antenna element overlap the feeding line in plan view.

In such an array antenna, the array antenna includes:

an other substrate made of a dielectric material, wherein the feeding element is provided on a surface side of the other substrate, the substrate and the other substrate are stacked with a back surface side of the substrate and a front surface side of the other substrate.

In such an array antenna, the feeding line is a corner feeding where power is supplied from one end of an array in which antenna elements are arranged, or a central feeding where power is supplied from a center of the array in opposite directions to each other. Furthermore, when the feeding line is the central feeding and radiates polarization along an array direction or radiates polarization that is shifted with 45-degree from the array direction, phases of the power supplied from the center in opposite directions to each other are shifted with 180 degrees.

In such an array antenna, the feeding element is a slot or a patch.

From another point of view, an antenna element to which the present invention is applied includes: a feeding element; and plural parasitic elements provided to face the feeding element, wherein the plural parasitic elements include at least a pair of parasitic elements, the pair of the parasitic elements being separately provided with a H-plane in a center of the feeding element as a border and are excited in-phase in a basic mode. Furthermore, the plural parasitic elements include a parasitic element that is not separately provided with the H-plane in the center of the feeding element as a border.

In such an antenna element, the array element includes: a substrate on whose surface side the plural parasitic elements are provided, wherein the feeding element is provided on a back surface side of the substrate or provided to be in contact with the back surface side of the substrate.

Furthermore, in such an antenna element, the antenna element includes: an other substrate on whose surface side the feeding element is provided, wherein the substrate and the other substrate are stacked with a back surface side of the substrate and a front surface side of the other substrate.

Furthermore, in such an antenna element, the feeding element is a slot or a patch.

### Effect of the Invention

According to the present invention, it is possible to provide an array antenna with series feeding method and having a wider bandwidth and the like.

### BRIEF DESCRIPTION OF DRAWINGS

FIGS. 1A and 1B illustrate a planar antenna as an example of an application of an array antenna to which the present invention is applied. FIG. 1A is a plan view, and

FIG. 1B illustrates a radiation direction of radio wave.

FIGS. 2A and 2B illustrate a feeding method of the array antenna. FIG. 2A shows an array antenna with a series feeding method, and FIG. 2B shows an array antenna with a parallel feeding method.

FIGS. 3A and 3B illustrate an example of an array antenna to which the exemplary embodiment is applied. FIG. 3A is a perspective view, and FIG. 3B is a cross-sectional view of the area surrounded by a dash-dot line in FIG. 3A.

FIGS. 4A to 4D illustrate shapes and dimensions of parasitic elements that a parasitic element part of the antenna element has, the antenna element being provided by the array antenna to which the exemplary embodiment is applied. FIG. 4A shows the planar shape of the parasitic element part with one parasitic element, FIG. 4B shows the planar shape of the parasitic element part with five parasitic elements, FIG. 4C shows the planar shape of the parasitic element part with four parasitic elements, and FIG. 4D shows the dimensions of the parasitic elements.

FIGS. 5A and 5B illustrate an array antenna to which the exemplary embodiment is not applied, which is shown for comparison. FIG. 5A is a perspective view, and FIG. 5B is a cross-sectional view of the area surrounded by a dash-dot line in FIG. 5A.

FIGS. 6A and 6B illustrate shapes and dimensions of parasitic elements that a parasitic element part of the antenna element has, the antenna element being provided by the array antenna to which the exemplary embodiment is not applied. FIG. 6A shows the planar shape of the parasitic element part with parasitic elements, and FIG. 6B shows the dimensions of the parasitic elements.

FIG. 7 illustrates the relative radiated power and radiation performance which are set for the antenna element of the array antenna.

FIGS. 8A and 8B illustrate radiation characteristics (design values) and reflection characteristics of the array antenna. FIG. 8A shows the radiation characteristics (design values) and FIG. 8B shows the reflection characteristics.

FIGS. 9A to 9C illustrate the directivity characteristics in the vertical (E) plane of the array antenna to which the exemplary embodiment is applied. FIG. 9A is for a frequency of 27.5 GHZ, FIG. 9B is for a frequency of 28.5 GHZ, and FIG. 9C is for a frequency of 29.5 GHZ.

FIGS. 10A to 10C illustrate the directivity characteristics in the horizontal (H) plane of the array antenna to which the exemplary embodiment is applied. FIG. 10A is for a frequency of 27.5 GHZ, FIG. 10B is for a frequency of 28.5 GHZ, and FIG. 10C is for a frequency of 29.5 GHZ.

FIGS. 11A to 11C illustrate the reflection characteristic of an antenna element with a single parasitic element in the parasitic element part. FIG. 11A is a perspective view of the antenna element, FIG. 11B is a cross-sectional view of the area surrounded by a dash-dot line in FIG. 11A, and FIG. 11C is the reflection characteristic with different radiation performance.

FIGS. 12A to 12C illustrate the reflection characteristic in an antenna element with four parasitic elements in the parasitic element part. FIG. 12A is a perspective view of the antenna element, FIG. 12B is a cross-sectional view of the area surrounded by a dash-dot line in FIG. 12A, and FIG. 12C is the reflection characteristic when the radiation performance is 100%.

FIGS. 13A and 13B illustrate the electric field distribution in a parasitic element part with multiple parasitic elements. FIG. 13A is the case of two parasitic elements, and FIG. 13B is the case of five parasitic elements.

FIGS. 14A to 14D illustrate parasitic element parts. FIG. 14A is the case of one parasitic element, FIG. 14B is the case of five parasitic elements, FIG. 14C is the case of four parasitic elements, and FIG. 14D is the case of two parasitic elements.

FIG. 15 illustrates the reflection characteristics of the antenna elements provided by the array antenna to which the exemplary embodiment is applied.

FIGS. 16A to 16D illustrate the shape of the feeding elements (slots). FIG. 16A shows a rectangular shape, FIG. 16B shows a dumbbell shape, FIG. 16C shows a bow-tie shape, and FIG. 16D shows an H-shaped shape.

FIGS. 17A to 17C illustrate the antenna element with 45-degree polarization to which the exemplary embodiment is applied. FIG. 17A is a perspective view of the antenna element, FIG. 17B is a cross-sectional view of the area surrounded by a dash-dot line in FIG. 17A and also a cross-sectional view of the XVIIB-XVIIB line in FIG. 17C, and FIG. 17C is a plan view from the parasitic element part.

FIGS. 18A to 18C illustrate the antenna element with horizontal polarization to which the exemplary embodiment is applied. FIG. 18A is a perspective view of the antenna element, FIG. 18B is a cross-sectional view of the area surrounded by a dash-dot line in FIG. 18A and also a cross-sectional view of the XVIIIB-XVIIIB line in FIG. 18C, and FIG. 18C is a plan view from the parasitic element part.

FIGS. 19A and 19B illustrate an example of an antenna element to which a coplanar feeding line is applied, which is a modification example 1 of the exemplary embodiment. FIG. 19A is a perspective view of the antenna element, and FIG. 19B is a cross-sectional view of the area surrounded by a dash-dot line in FIG. 19A.

FIGS. 20A and 20B illustrate an example of an antenna element to which a feeding element (a patch) is applied, which is a modification example 2 of the exemplary embodiment. FIG. 20A is a perspective view of the antenna element, and FIG. 20B is a cross-sectional view of the area surrounded by a dash-dot line in FIG. 20A.

### DESCRIPTION OF EMBODIMENTS

Hereinafter, the exemplary embodiment of the present invention will be described in detail with reference to the accompanying drawings. The same signs may be used for components that have similar functions. In addition, some configurations may be signed, and similar configurations may not be signed. In the following, antennas (array antennas and antenna elements) are described as they radiate or transmit radio waves, but can also receive radio waves due to the reversibility of the antenna.

### (Planar Antenna 100)

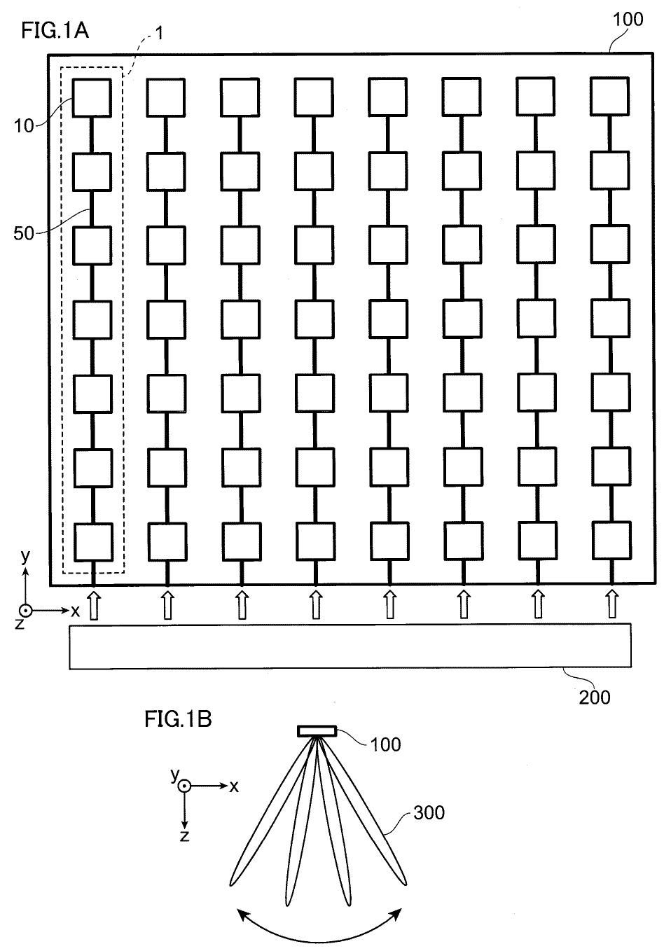

FIGS. 1A and 1B illustrate a planar antenna 100 as an example of an application of an array antenna 1 to which the exemplary embodiment is applied. FIG. 1A is a plan view, and FIG. 1B illustrates a radiation direction of radio wave. In FIG. 1A, the right direction of the paper surface is referred to as x direction, the top direction of the paper surface is referred to as y direction, and the front surface direction of the paper surface is referred to as z direction. In FIG. 1B, the right direction of the paper surface is referred to as x direction, the bottom direction of the paper surface is referred to as z direction, and the front surface direction of the paper surface is referred to as y direction. In addition to the planar antenna 100, a control unit 200 that controls the planar antenna 100 is illustrated in FIG. 1A.

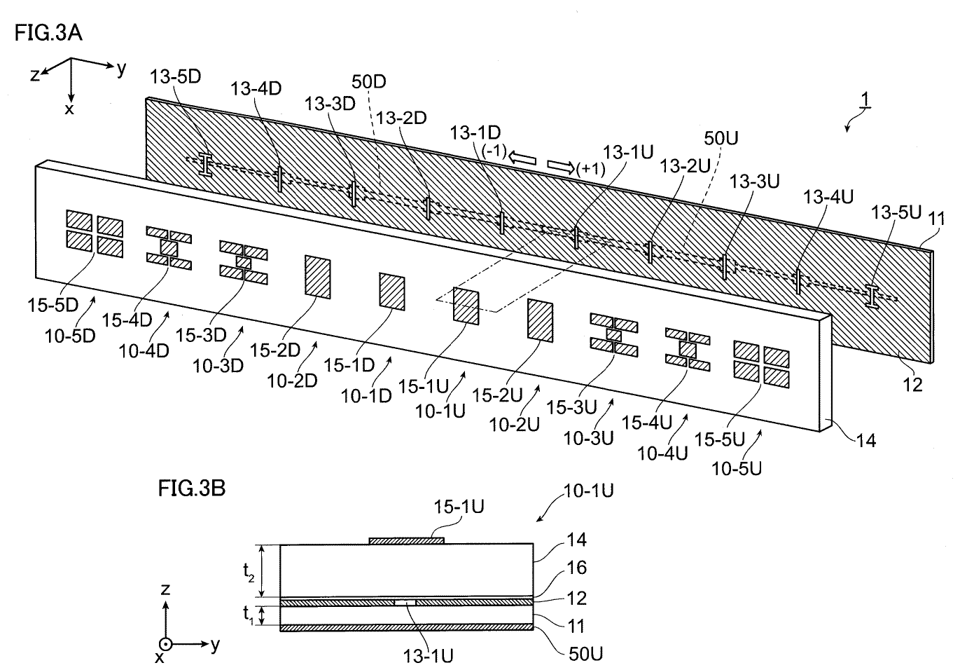

As shown in FIG. 1A, the planar antenna 100 has plural array antennas 1 (eight in FIG. 1A). The plural array antennas 1 are arranged in parallel in the x direction. The array antenna 1 is equipped with plural antenna elements 10 (seven in FIG. 1A) and a feeding line 50. In the array antenna 1, the plural antenna elements 10 are arranged in a straight line in the y direction. The feeding line 50 is connected in series to the plural antenna elements 10. Here, as an example, a feeding element 13 (see FIGS. 3A and 3B described later) of the antenna elements 10 is a slot, and the feeding line 50 is overlapped in plan view with the antenna elements 10 so as to feed the slot. The feeding line 50 is connected to the control unit 200 at an end in the −y direction. The control unit 200 supplies power to the feeding line 50 to radiate radio waves to the antenna elements 10 of the array antenna 1, as shown by the white arrows. In other words, the plural antenna elements 10 of the array antenna 1 are powered in series feeding method by the feeding line 50. The plan view means that the components (in FIG. 1A, the antenna elements 10 and the feeding lines 50) are seen through from the z direction.

The same shall apply in other cases.

The antenna element 10 may be described as an antenna because the antenna element 10 radiates radio waves even when standing alone. In the present specification, the antenna element 10 is described as antenna element 10 to distinguish from the array antenna 1. The antenna element 10 is sometimes referred to as a radiating element.

The array antenna 1 is sometimes referred to as a linear array antenna or a linear array because plural antenna elements 10 which are fed by the single power supply feed line 50 are arranged in a straight line. In the array antenna 1, the direction in which the antenna elements 10 are arranged (in FIGS. 1A and 1B, the +y direction) is denoted as an array direction. In FIG. 1A, the plural antenna elements 10 are arranged in a straight line in the y direction, however, some of the antenna elements 10 may be arranged in a shifted manner in the +x or −x direction. For example, the plural antenna elements 10 may be arranged in a zigzag manner. Furthermore, the plural antenna elements 10 may be arranged in arcs shape.

As shown in FIG. 1B, when the plural array antennas 1 are fed with power in-phase (no phase difference), the planar antenna 100 radiates radio waves 300 in the z direction. On the other hand, when the array antennas 1 are fed with power with a phase difference, as shown by the arrows, the direction in which radio waves 300 are radiated can be tilted toward the −x direction or tilted toward the +x direction.

The planar antenna 100 in which the plural array antennas 1 are arranged in parallel is described as an application example of using the array antennas 1. The array antenna 1 may also be used as a stand-alone antenna. In the following, the array antenna 1 is described.

### (Series Feeding Method)

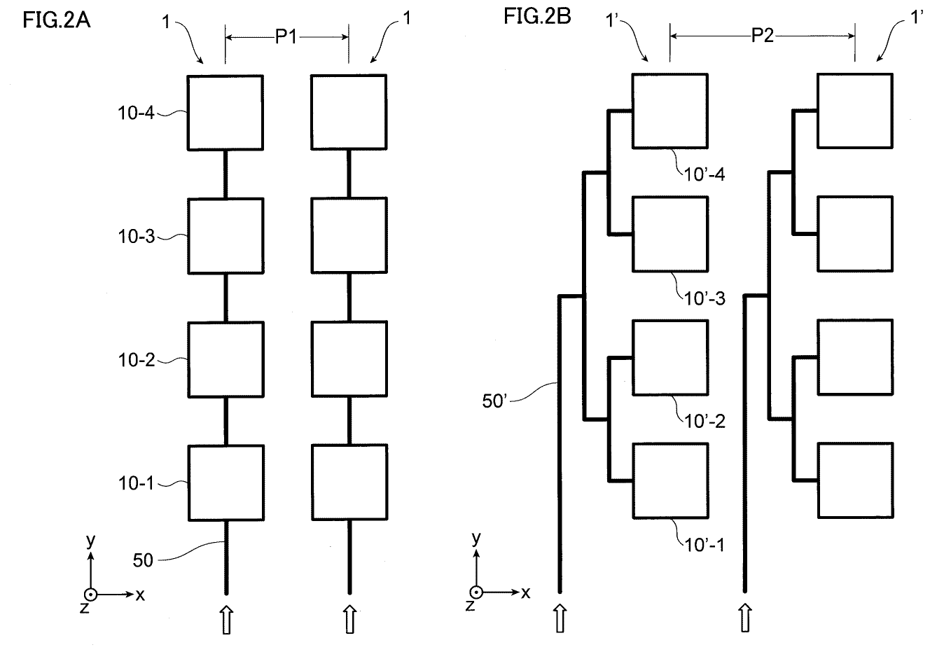

FIGS. 2A and 2B illustrate a feeding method of the array antenna 1. FIG. 2A shows the array antenna 1 with a series feeding method, and FIG. 2B shows the array antenna 1′ with a parallel feeding method. The x, y, and z directions are the same as in FIG. 1A. Hereinafter, the array antennas 1, 1′, etc. may be denoted “array antenna” without the sign. Similarly, the antenna element 10, etc. may be denoted “antenna element” without the sign. The same shall apply to other terms.

FIG. 2A shows two series feeding array antennas 1 arranged in parallel. The array antenna 1 has plural antenna elements 10 (in FIG. 2A, antenna elements 10-1 to 10-4) and the feeding line 50. As mentioned above, the plural antenna elements 10 are arranged on the feeding line 50 and along the feeding line 50. As shown by the white arrows, the feeding line 50 is fed in the y direction from the end of the −y direction side.

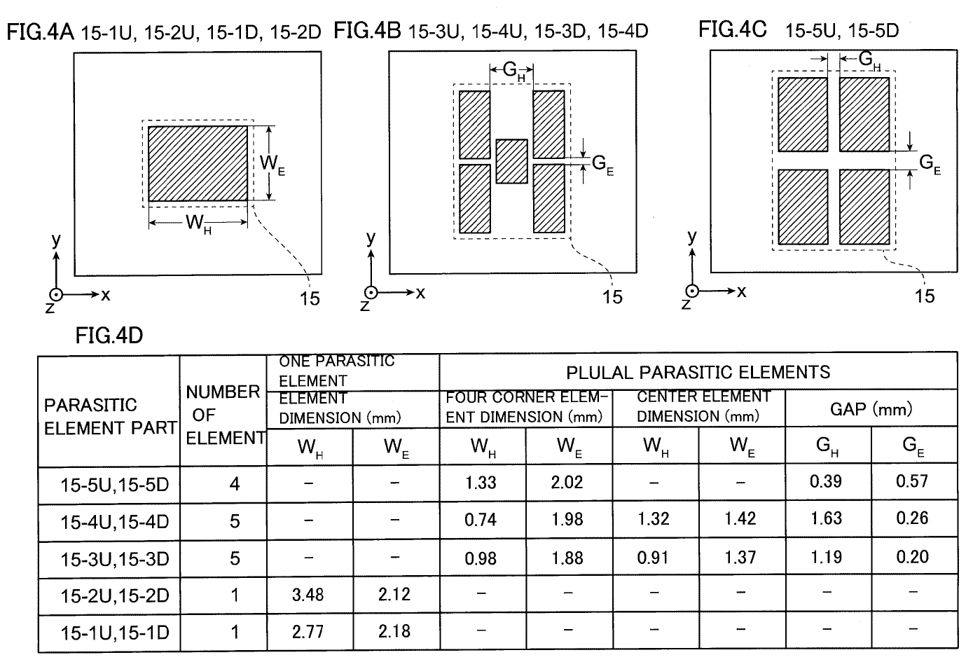

In the series feeding method, the plural antenna elements 10 are fed by one feeding line 50. Specifically, as shown in FIGS. 4A and 4B described later, the supplied power is sequentially distributed to the antenna elements 10 along the feeding line 50. In the power supplied to antenna element 10-1, the remaining power after the antenna element 10-1 radiated as radio waves is supplied to the antenna element 10-2 side. Next, the remaining power after the antenna element 10-2 radiated as radio waves is supplied to the antenna element 10-3 side. In other words, in the antenna elements 10 connected to the feeding line 50 in series, the remaining power after the upstream antenna element 10 radiated as radio waves is supplied to the downstream antenna element 10. In this way, power is sequentially supplied to all the antenna elements 10 connected to the feeding line 50.

A pitch (distance) between the two array antennas 1 arranged in parallel is defined as a pitch P1. In series feeding, the pitch P1 remains the same even if the number of antenna elements 10 comprising the array antenna 1 increases. For example, the pitch P1 is set between 0.5λ and 1.0λ when the center wavelength is A. When the frequency is 28 GHZ, the pitch P1 is 5.4 mm to 10.7 mm. When the frequency is 60 GHz, the pitch P1 is 2.5 mm to 5 mm.

FIG. 2B shows two array antennas 1′ with parallel feeding method arranged in parallel. The array antenna 1′ with parallel feeding method has plural antenna elements 10′ (in FIG. 2B, antenna elements 10′-1 to 10′-4) and a feeding line 50′. The feeding line 50′ is branched in a tournament manner. Then, the antenna elements 10′ are connected to ends which are branched in the tournament manner. As shown by the white arrows, the feeding line 50′ is supplied with power from an end in the −y direction side.

In the parallel feeding method, the length of the feeding line 50′ is set so that the length from the end where power is supplied to the antenna element 10′ is the same. Therefore, in the parallel power feeding, power is supplied to the plural antenna elements 10′ in parallel.

A pitch (distance) between the two array antennas 1′ arranged in parallel is defined as a pitch P2. In the parallel power feeding method, the feeding line 50′ is branched in a tournament manner, so the feeding line 50′ is provided in the gap between the array antennas 1′. Therefore, the pitch P2 is larger than the pitch P1 between the two array antennas 1 in the series feeding method shown in FIG. 2A (P1<P2). The more the number of antenna elements 10′ comprising the array antenna 1′ increases, the larger the scale of the feeding line 50′ becomes, and the larger the pitch P2 becomes.

As explained above, when plural array antennas are arranged in parallel, such as the planar antenna 100 shown in FIG. 1, the feeding line 50 of the series feeding method is smaller in scale than the feeding line 50′ of the parallel feeding method. In other words, the pitch P1 between the array antennas 1 in the series feeding method becomes smaller than the pitch P2 between the array antennas 1′ in the parallel feeding method, and the planar antenna 100 becomes smaller.

In the series feeding method, an excitation method for the antenna element 10 in the array antenna 1 includes: a traveling wave type and a standing wave type. The standing wave type is a method in which the antenna elements 10 are designed for the array antenna 1 as a whole. In contrast, the traveling wave type is a method in which the antenna elements 10 of the array antenna 1 are designed as a unit. In the traveling wave type, it is easy to design the array antenna 1 because the characteristics can be adjusted for each of the antenna elements 10. In the following, the array antenna 1 is described as a traveling wave type.

### (Array Antenna 1)

FIGS. 3A and 3B illustrate an example of an array antenna 1 to which the exemplary embodiment is applied. FIG. 3A is a perspective view, and FIG. 3B is a cross-sectional view of the area surrounded by a dash-dot line in FIG. 3A. In FIG. 3A, the short direction of the array antenna 1 is referred to as x direction, the long direction is referred to as y direction, and the direction perpendicular to the x-y plane is referred to as z direction. In FIG. 3B, the right direction of the paper surface is referred to as y direction, the upper direction of the paper surface is referred to as z direction, and the front surface direction of the paper surface is referred to as x direction. The array antenna 1 may be denoted as the Example. Y direction is the direction perpendicular to the ground surface (vertical direction), and X direction is the direction horizontal to the ground surface (horizontal direction).

As shown in FIG. 3A, the array antenna 1 has ten antenna elements 10 (antenna elements 10-1U to 10-5U, 10-1D to 10-5D) and feeding lines 50 (feeding lines 50U, 50D). Each of the antenna elements 10-1U to 10-5U and 10-1D to 10-5D respectively has a substrate 11 made of dielectric material, a ground conductor 12 made of conductive material, the feeding elements 13-1U to 13-5U, 13-1D to 13-5D, a substrate 14 made of a dielectric material, and parasitic element parts 15-1U to 15-5U and 15-1D to 15-5D made of conductive material. For example, the antenna element 10-1U has a substrate 11, a ground conductor 12, a feeding element 13-1U, a substrate 14, and a parasitic element part 15-1U. When the feeding elements 13-1U to 13-5U and 13-1D to 13-5D are not distinguished respectively, they are denoted as feeding element 13, and when the parasitic element parts 15-10 to 15-5U and 15-1D to 15-5D are not distinguished respectively, they are denoted as parasitic element part 15.

As shown in FIG. 3A, in the array antenna 1, ten antenna elements 10 are arranged in the +y direction (array direction) in the order from the antenna element 10-5D to the antenna element 10-5U. The array antenna 1 is configured symmetrically in the #y direction with the center of the array direction (+y direction) as a border. The feeding line 50U supplies power from the center of the array direction (+y direction) to the ty direction (array direction side), and the feeding line 50D supplies power from the center of the array direction (+y direction) to the −y direction (reverse array direction side). In other words, the feeding line 500 and the feeding line 50D supply power in opposite directions each other. As an example, the feeding lines 50U and 50D supply power whose phases are reversed (shifted by 180°). In FIG. 3A, the feeding line 500 is marked +1 with a white arrow, and the feeding line 50D is marked −1 with a white arrow. This is denoted as a central feeding. As mentioned above, the +y direction side is marked with U and the −y direction side is marked with D to distinguish the two.

The ground conductor 12 is provided on the surface (a surface in the +z direction side) side of the substrate 11. The ground conductor 12 is set to a reference potential (e.g., ground potential). The feeding element 13 is an opening (slot) provided by removing the ground conductor 12. In the following, the feeding element 13 is denoted as feeding element (slot) 13. The feeding line 50 is provided on the back surface (a surface in the −z direction side) of the substrate 11. The feeding line 500 is provided so that the feeding line 500 overlaps the feeding elements 13-1U to 13-5U in plan view. The feeding line 50D is provided so that the feeding line 50D overlaps the feeding elements 13-1D to 13-5D in plan view. The feeding elements 13-1U to 13-4U and 13-1D to 13-4D are rectangular slots with the long side in the x direction and the short side in the y direction, and the feeding elements 13-5U and 13-5D are H-shaped slots with rectangles at both ends of the rectangle that are long in the y direction and short in the x direction. The plural feeding elements 13 are collectively fabricated on the substrate 11. The surface side of the substrate 11 means that it may be the surface of the substrate 11, or in the case that other components are provided on the surface of the substrate 11, it may be the surface of the other components. The same applies to the back surface side.

The parasitic element part 15 is provided on the surface (a surface in the +z direction side) side of the substrate 14. The parasitic element parts 15-1U, 15-2U, 15-1D, and 15-2D have one parasitic element. The parasitic element parts 15-3U, 15-4U, 15-3D, and 15-4D have five parasitic elements. The parasitic element parts 15-5U and 15-5D have four parasitic elements. The plural parasitic element parts 15 are collectively fabricated on the substrate 14. The surface side of the substrate 14 may be the surface of the substrate 14 or the surface of another component on the surface of the substrate 14. The parasitic element part 15 refers to an area where plural parasitic elements are provided when plural parasitic elements are included, and more specifically, an area surrounding outer edges of the plural parasitic elements, as shown in a dashed line in FIG. 4A described later.

In the perspective view of FIG. 3A, a space is shown between the ground conductor 12 (the feeding element 13) provided on the surface side of the substrate 11 and the substrate 14 provided with the parasitic element part 15. This is to illustrate the structure, thus as shown in FIG. 3B, no space is provided between the ground conductor 12 on the surface side of substrate 11 and substrate 14. In the frequency band higher than sub-millimeter wave band, the wavelength λ is equal to or less than four times the thickness of substrate 14 (thickness t₂ of the substrate 14 shown in FIG. 3B) where the parasitic element part 15 is provided (t₂<λ/4), thus space is not necessary to be provided between the ground conductor 12 (the feeding element 13) on the surface side of the substrate 11 and the substrate 14 provided with the parasitic element part 15. In other words, the array antenna 1 is composed of two substrates 11 and 14 by stacking with each other. Therefore, the array antenna 1 used in the frequency band higher than sub-millimeter wave band is a low profile and simple in structure to be easily manufactured. The surface side of the substrate 11 may be the surface of the substrate 11 or the surface of another component on the surface of the substrate 11.

In the antenna element 10-1U shown as an example in FIG. 3B, the feeding line 50 is provided on the back surface (a surface in the −z direction side) side of the substrate 11, and the ground conductor 12 is provided on the surface (a surface in the +z direction side) side of the substrate 11. A slot that functions as the feeding element 13-1U is provided in the ground conductor 12. As mentioned above, the feeding line 50 and the feeding element (slot) 13-1U face each other across the substrate 11. The parasitic element part 15 is provided on the surface (a surface in the +z direction side) side of the substrate 14. The ground conductor 12 provided on the surface side of the substrate 11 and the back surface side of the substrate 14 are bonded together by an insulating adhesive sheet (bonding sheet) 16. As a result, the feeding element 13-1U and the parasitic element part 15-1U face each other across the substrate 14. In other words, the feeding element 13-1U is provided in contact with the back surface side of the substrate 14 on part which the parasitic element 15-1U is provided. Although the adhesive sheet 16 is used here, it is sufficient as long as the substrate 11 with the feeding element 13 (slot) on the surface side and the substrate 14 provided with the parasitic element part 15 on the surface side are overlapped so that there is no space (gap) between the surface side of substrate 11 and the back surface side of substrate 14. In other words, the feeding element (slot) 13 should be provided so that the feeding element (slot) 13 contacts the back surface side (in FIG. 3B, the adhesive sheet 16 side) of the substrate 14 on which the parasitic element part 15-1U is provided. The ground conductor 12 may be provided on the back surface side of the substrate 14.

As explained above, the feeding lines 50U, the feeding elements (slots) 13-1U to 13-5U, and the parasitic element parts 15-1U to 15-5U are provided to be overlapped in plan view. In addition, the feeding line 50D, the feeding elements (slots) 13-1D to 13-5D, and the parasitic element parts 15-1D to 15-5D are provided to be overlapped in plan view. In other words, the feeding line 50, the feeding element (slot) 13, and the parasitic elements 15 are provided to be overlapped in plan view. The feeding elements (slot) 13 is fed from the feeding line 50, and the parasitic element in the parasitic element parts 15 is excited by electromagnetically coupling with the feeding element 13.

In the above, the substrate 11, the ground conductor 12, and the substrate 14 are continuous between the antenna elements 10 in the array antenna 1. Here, it is assumed that each antenna element 10 is provided with the substrate 11, the ground conductor 12, and the substrate 14.

The feeding line 50 is provided on the back surface side of the substrate 11, and the ground conductor 12 is provided on the front side of the substrate 11. The feeding line 50 constitutes a microstrip line (MSL). In addition, since the feeding element 13 is a slot, the antenna element 10 is a microstrip antenna (MSA). Since the antenna element 10 has the parasitic element parts 15 with the parasitic element, the antenna element 10 may be referred to as a microstrip antenna with a parasitic element (MSA). The microstrip antenna (MSA) can be broadband by including a parasitic element.

In the array antenna 1, the shape of the feeding lines 50, the shape of the feeding elements (slots) 13, and the number of parasitic elements in the parasitic element parts 15 are changed for each antenna element 10. This is due to the fact that an array antenna with antenna elements of the same configuration cannot be broadband.

In the array antenna 1 to which the exemplary embodiment is applied, the number of parasitic elements that the parasitic element part 15 in the antenna element 10 has is different among the antenna elements 10. Any of antenna elements 10-1U to 10-2U and 10-1D to 10-2D with one parasitic element is an example of a first antenna element, any of antenna elements 10-3U to 10-4U and 10-3D to 10-4D with five parasitic elements and antenna elements 10-5U and 10-5D with four parasitic elements is an example of a second antenna element. In addition, any of antenna elements 10-3U to 10-4U and 10-3D to 10-4D with five parasitic elements can be an example of the first antenna element, and antenna elements 10-5U and 10-5D with four parasitic elements can be used as an example of the second antenna element. One of the two antenna elements 10 with different numbers of the parasitic elements in the parasitic element part 15 is an example of the first antenna element, and the other is an example of the second antenna element. The substrate 14 is an example of a substrate and the substrate 11 is an example of another substrate.

FIGS. 4A to 4D illustrate shapes and dimensions of parasitic elements that the parasitic element part 15 of the antenna element 10 has, the antenna element 10 being provided by the array antenna 1 to which the exemplary embodiment is applied. FIG. 4A shows the planar shape of the parasitic element parts 15-1U, 15-2U, 15-1D, and 15-2D with one parasitic element, and FIG. 4B shows the planar shape of the parasitic element parts 15-3U, 15-4U, 15-3D, and 15-4D with five parasitic elements, FIG. 4C shows the planar shape of the parasitic element parts 15-5U, 15-5D with four parasitic elements, and FIG. 4D shows the dimensions of the parasitic elements. In FIGS. 4A to 4C, the horizontal direction of the paper surface is referred to as x direction, the upper direction of the paper surface is referred to as y direction, and the front surface direction of the paper surface is referred to as z direction. In FIG. 4D, the unit of dimension of the parasitic elements is mm. Here, the design center frequency of the array antenna 1 is set to 28.5 GHz.

The substrate 11 is for example, a printed circuit board with a thickness t₁ of 0.127 mm, and a relative permittivity of 2.19. The substrate 14 is for example, a printed circuit board for high frequencies with a thickness t₂ of 0.76 mm, and a relative permittivity of 3.3. The conductive material is, for example, copper (Cu). The conductive material may be copper (Cu), aluminum (Al), silver (Ag), gold (Au), or alloys containing these materials.

FIG. 4A shows one parasitic element. The planar shape of the parasitic element is rectangular, and the width in the x direction is referred to as width WH and the width in the y direction is referred to as width WE. The same is true for the parasitic element in FIG. 4B and FIG. 4C. Note that H is the magnetic field direction and E is the electric field direction. FIG. 4D shows the dimensions (element dimensions (mm)) of one parasitic element (denoted as one parasitic element) that the parasitic element parts 15-1U, 15-2U, 15-1D, and 15-2D have.

FIG. 4B shows five parasitic elements. Two pairs of the two parasitic elements arranged in the y direction are located at an end of the ±x direction, and one parasitic element is located at the center of the x direction. The four parasitic elements located at the ±x ends are referred to as four corner elements, and the parasitic element located at the center of the x direction is referred to as a central element. The planar shape of the four corner elements is the same. The distance in the y direction between the two parasitic elements arranged in the y direction is referred to as gap G_{E} and the distance in the x direction between the two pairs of elements arranged in the y direction is referred to as gap G_{H}. In FIG. 4D, for the five parasitic elements (multiple parasitic elements) that 15-3U, 15-4U, 15-3D, and 15-4D with five parasitic elements have, the dimensions of the four corner elements (four corner element dimensions (mm)), center element dimensions (center element dimensions (mm)), gaps G_{H} and G_{E} (gaps (mm)) are shown.

FIG. 4C shows four parasitic elements. Two pairs of the two parasitic elements arranged in the y direction are located in the x direction. These four parasitic elements are referred to as four corner elements. The planar shape of the four corner elements is the same. The distance in the y direction between the parasitic elements is referred to as gap G_{E}, and the distance in the x direction between the parasitic elements is referred to as gap G_{H}. In FIG. 4D, for the four parasitic elements (multiple parasitic elements) that 15-5U and 15-5D with four parasitic elements have, the dimensions of the four corner elements (four corner element dimensions (mm)), gaps G_{H} and G_{E} (gaps (mm)) are shown.

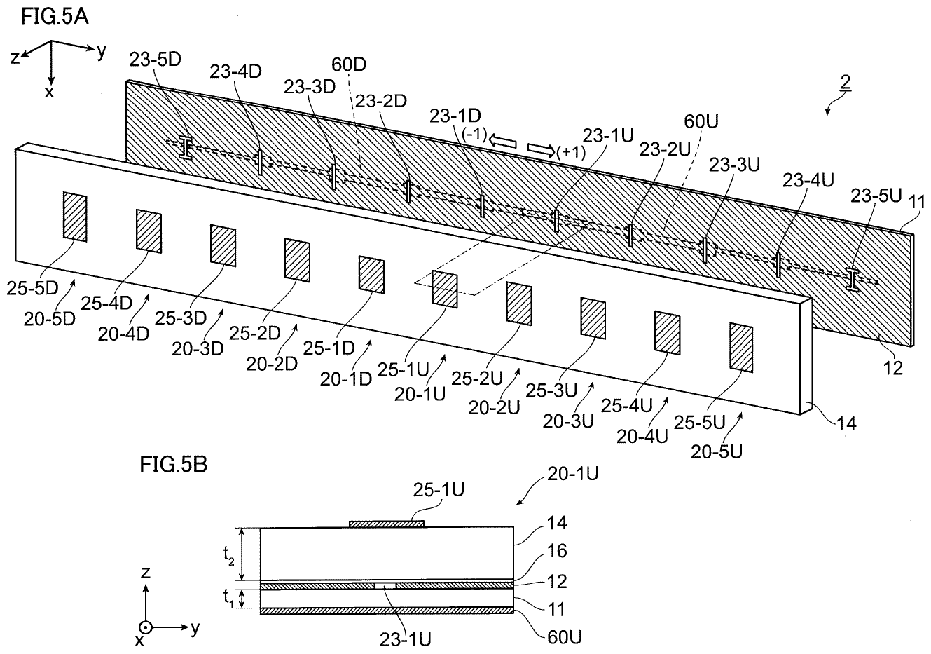

FIGS. 5A and 5B illustrate an array antenna 2 to which the exemplary embodiment is not applied, which is shown for comparison. FIG. 5A is a perspective view, and FIG. 5B is a cross-sectional view of the area surrounded by a dash-dot line in FIG. 5A. The array antenna 2 may be denoted as a comparative example. The x, y, and z directions in FIGS. 5A and 5B are the same as in FIGS. 3A and 3B.

As shown in FIG. 5A, the array antenna 2 has ten antenna elements 20 (antenna elements 20-1U to 20-5U and 20-1D to 20-5D) and feeding lines 60 (feeding lines 60U, 60D). Each of the antenna elements 20-1U to 20-5U and 20-1D to 20-5D has respectively a substrate 11 made of dielectric material, a ground conductor 12 made of conductive material, feeding elements 23-1U to 23-5U and 23-1D to 23-5D, a substrate 14 made of dielectric material, and parasitic element parts 25-1U to 25-5U and 25-1D to 25-5D made of dielectric material. When the feeding elements 23-1U to 23-5U and 23-1D to 23-5D are not distinguished from each other, they are denoted as feeding element 23, and when the parasitic element parts 25-1U to 25-5U and 25-1D to 25-5D are not distinguished from each other, they are denoted as parasitic element part 25.

As shown in FIG. 5A, the array antenna 2 has ten antenna elements 20 arranged in the +y direction (array direction) in the order of antenna elements 20-5D to 20-5U. The array antenna 2 is symmetrical in the ty direction with the center of the array direction (+y direction) as a border.

The ground conductor 12 is provided on the surface (+z direction side) side of the substrate 11. The feeding elements 23 of the antenna elements 20 (antenna elements 20-1U to 20-5U, 20-1D to 20-5D) are openings (slots) which are provided by removing the ground conductor 12. The feeding lines 60 are provided on the back surface side (−z direction side) of the substrate 11. The feeding element (slot) 23 and the feeding line 60 are similar to the feeding element (slot) 13 and the feeding line 50 of the array antenna 1, however, the dimensions are different in some parts.

The parasitic element part 25 of the antenna elements 20 (antenna elements 20-1U to 20-5U, 20-1D to 20-5D) is provided on the surface (+z direction side) side of the substrate 14. The parasitic element part 25 is different from the parasitic element part 15 of the antenna element 10 in the array antenna 1. The parasitic element parts 25-1U to 25-5U and 25-1D to 25-5D have one parasitic element.

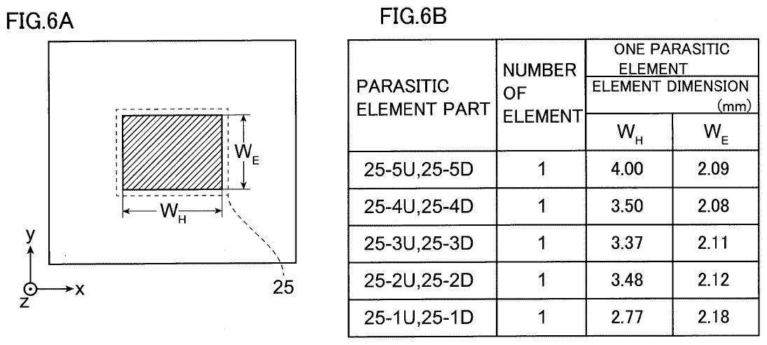

FIGS. 6A and 6B illustrate shapes and dimensions of parasitic elements that the parasitic element part 25 of the antenna element 20 has, the antenna element 20 being provided by the array antenna 2 to which the exemplary embodiment is not applied. FIG. 6A shows the planar shape of the parasitic element part 25 with parasitic elements, and FIG. 6B shows the dimensions of the parasitic elements. The x, y, and z direction in FIG. 6A is the same as in FIG. 4A. In FIG. 6B, the dimensions of the parasitic elements are shown in mm. Again, here, the design center frequency of the array antenna 1 is set to 28.5 GHZ.

As mentioned above, the parasitic element part 25 of the antenna element 20 in the array antenna 2 has one parasitic element, respectively. The dimensions of the parasitic elements of the parasitic element parts 25-1U, 25-20, 25-1D, and 25-2D are the same as those of the parasitic element part 15-1U, 15-2U, 15-1D, 15-2D of the antenna element 10 in the array antenna 1.

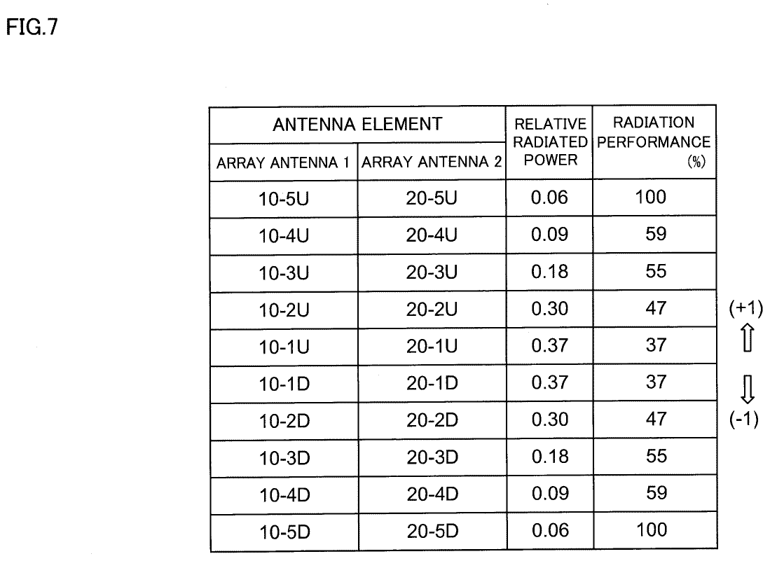

FIG. 7 illustrates the relative radiated power and radiation performance which are set for the antenna element 10 (antenna elements 10-1U to 10-5U and 10-1D to 10-5D) of the array antenna 1 and for the antenna element 20 (antenna elements 20-1U to 20-5U and 20-1D to 20-5D) of the array antenna 2. The relative radiated power is set at a side lobe level S.L.L. (Side Lobe Level) of about −25 dB. The relative radiated power is the relative amount when the input power is set to 1.

In FIG. 7, the relative radiated power of the array antenna 1 is set to be large in the center (antenna elements 10-1U and 10-1D) and to be smaller toward the ends (antenna elements 10-5U and 10-5D). In other words, the relative radiated power is set so that the antenna elements 10-1U and 10-1D radiate 37% thereof, the antenna elements 10-2U and 10-2D radiate 30% thereof, and the remaining antenna elements 10-3U to 10-5U and 10-3D to 10-5D radiate 33% thereof. In the array antenna 1, the antenna elements 10 marked with U and the antenna elements 10 marked with D are set symmetrically. The same is also true for the array antenna 2.

On the other hand, the radiation performance is the ratio of the power that the antenna elements 10 and 20 radiate as radio waves out of the input power. The relative power and the radiation performance are explained in the antenna element 10 with U in array antenna 1. Out of 100% of the input power, the antenna element 10-1U radiates 37%, which is the relative power. Therefore, the radiation performance of the antenna element 10-1U is 37%. The remaining power after radiation by the antenna element 10-1U is 63%. The antenna element 10-2U radiates 47% of the 63% power. Therefore, the relative amount of radiated power radiated by antenna element 10-2U is 1×0.63×0.47, resulting in 0.3, when the input power is 1. In this way, the radiation performance of antenna elements 10-3U to 10-5U is set. The antenna element 10-5U has a relative radiated power of 0.06 and radiates all of the input power, so the radiation performance of the antenna element 10-5U is 100%.

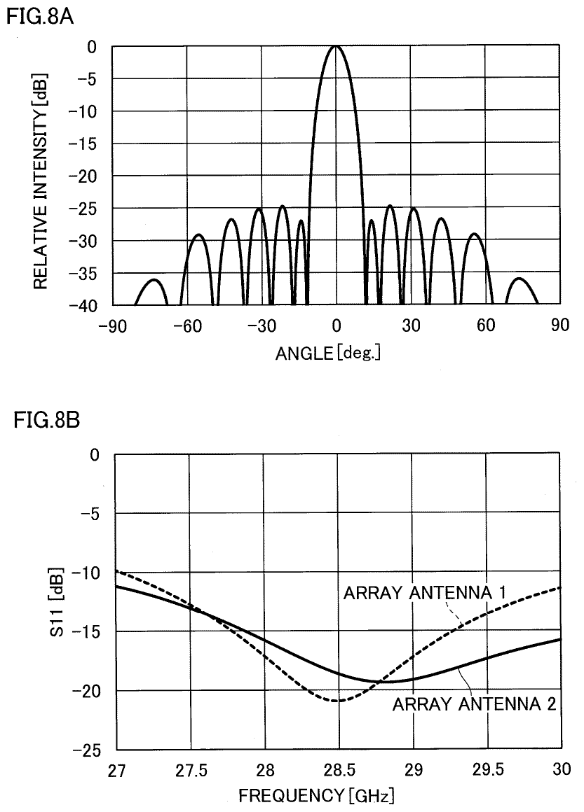

FIGS. 8A and 8B illustrate radiation characteristics (design values) and reflection characteristics of the array antenna 1 and the array antenna 2. FIG. 8A shows the radiation characteristics (design values) and FIG. 8B shows the reflection characteristics. The radiation characteristics (design values) in FIG. 8A is the radiation characteristic in the x-z plane at the center of the array antenna 1 in the y direction of FIG. 3A. The horizontal axis is the angle [deg.] with the z direction as 0 degree, and the vertical axis is the relative intensity [dB]. FIG. 8B shows the reflection characteristics in the z direction, where the horizontal axis is the frequency [GHz] and the vertical axis is the S parameter S11 [dB]. S11 is sometimes referred to as return loss.

As shown in FIG. 8A, the array antenna 1 and the array antenna 2 are set at a side lobe level S.L.L. (Side Lobe Level) of about −25 dB as described above.

As shown in FIG. 8B, S11 of the reflection characteristics in the array antenna 1 is smaller than S11 of in array antenna 2 at the low frequency side (27 GHZ side) and at the high frequency side (30 GHz side) across 28.5 GHZ. In the range from 27 GHz to 30 GHZ, S11 is kept equal to or below −10 dB. When frequency ratio bandwidth is calculated from this frequency range, the frequency ratio bandwidth is found to be equal to or more than 10%. The frequency ratio bandwidth is the ratio of the difference between the minimum frequency and maximum frequency at which the return loss is −10 dB or less with respect to the average value of the minimum frequency and maximum frequency.

The array antenna 1 has a wider bandwidth than the array antenna 2. This is due to the fact that in the array antenna 1, the number of parasitic elements that the parasitic element part 15 has differs among the antenna elements 10. In other words, the array antenna 1 includes parasitic element part 15 which has the plural parasitic elements, such as 15-3U, 15-4U, 15-5U, 15-3D, 15-4D, and 15-5D as shown in FIG. 3.

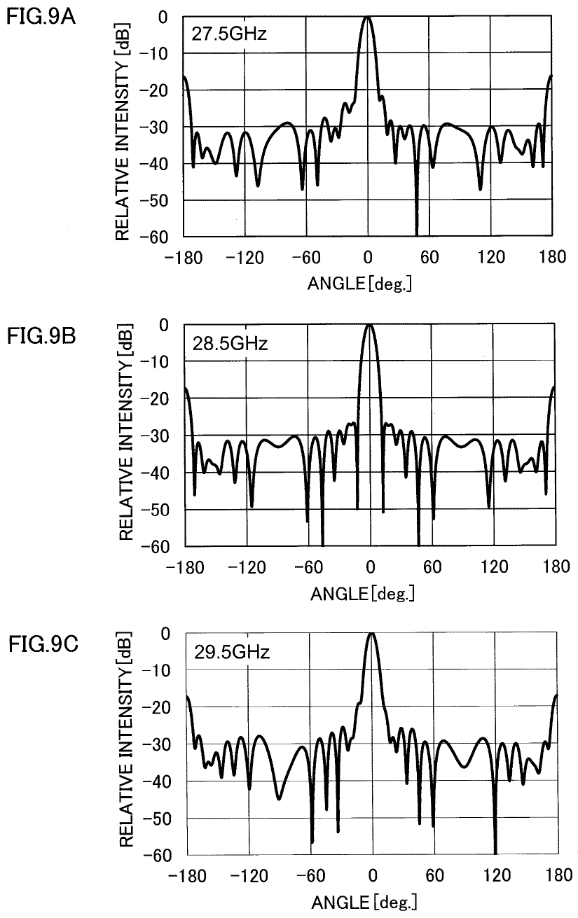

FIGS. 9A to 9C illustrate the directivity characteristics in the vertical (E) plane of the array antenna 1 to which the exemplary embodiment is applied. FIG. 9A is for a frequency of 27.5 GHZ, FIG. 9B is for a frequency of 28.5 GHZ, and FIG. 9C is for a frequency of 29.5 GHz. The vertical plane is the y-z plane in FIGS. 3A and 3B, which is perpendicular to the ground surface. The radio waves radiated by the array antenna 1 are vertical polarization. Cross polarization is not shown because it is less than −60 dB. Cross polarization is the horizontal polarization that intersects the vertical polarization. In FIGS. 9A to 9C, the horizontal axis is the angle [deg] with the z direction as 0 degree, and the vertical axis is the relative intensity [dB].

As shown in FIGS. 9A to 9C, the side lobes of the array antenna 1 are suppressed to about −25 dB for any frequency.

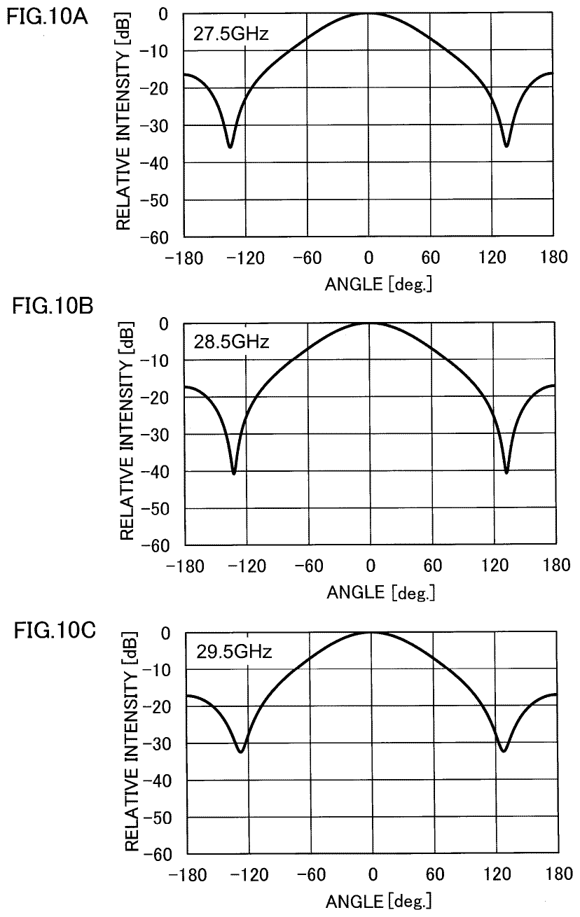

FIGS. 10A to 10C illustrate the directivity characteristics in the horizontal (H) plane of the array antenna 1 to which the exemplary embodiment is applied. FIG. 10A is for a frequency of 27.5 GHZ, FIG. 10B is for a frequency of 28.5 GHZ, and FIG. 10C is for a frequency of 29.5 GHZ. The horizontal plane is the x-z plane in FIGS. 3A and 3B, which is parallel to the ground surface. Cross polarization is not shown because it is less than −60 dB. In FIGS. 10A to 10C, the horizontal axis is the angle [deg] with the z direction as 0 degree, and the vertical axis is the relative intensity [dB].

When a beam width is defined at −3 dB, the beam width of approximately 75 degrees is obtained for any frequency, as shown in FIGS. 10A to 10C.

### (Antenna Element 10)

The antenna element 10 in the array antenna 1 differs in the number of parasitic elements that the parasitic element part 15 has. The array antenna 1 has a wider bandwidth than the array antenna 2 which includes the antenna elements 20 with the parasitic element part 25 having one parasitic element. In the following, the antenna elements 10 used in the array antenna 1 are described.

First, the array antenna 2, which is equipped antenna elements 20 in the parasitic element part 25 with one parasitic element, is described.

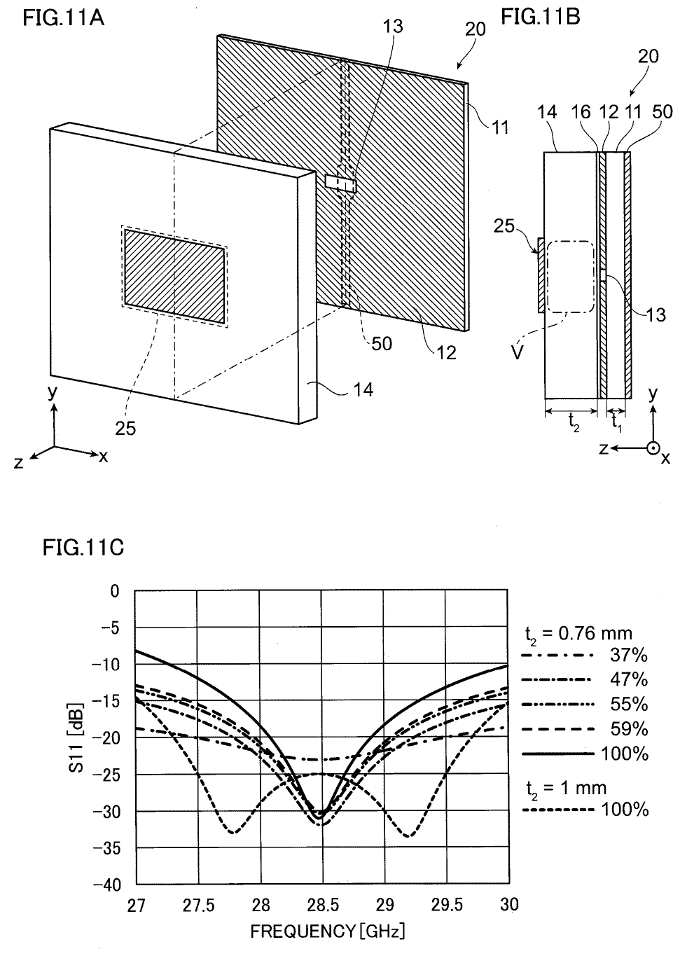

FIGS. 11A to 11C illustrate the reflection characteristic of the antenna element 20 with a single parasitic element in the parasitic element part 25. FIG. 11A is a perspective view of the antenna element 20, FIG. 11B is a cross-sectional view of the area surrounded by a dash-dot line in FIG. 11A, and FIG. 11C is the reflection characteristic with different radiation performance. In FIG. 11A, the horizontal direction of the antenna element 20 is referred to as x direction, the vertical direction of the antenna element 20 is referred to as y direction, and the direction perpendicular to the x-y plane is referred to as z direction. In FIG. 11B, the left direction of the paper surface is referred to as z direction, the top direction of the paper surface is referred to as y direction, and the front surface direction of the paper surface is referred to as x direction. In FIG. 11C, the horizontal axis is the frequency [GHz] and the vertical axis is the S parameter S11 [dB].

In the perspective view in FIG. 11A, a space is shown between the ground conductor 12 on the surface side of the substrate 11 and the substrate 14 on which the parasitic element part 25 is provided, however, this is to illustrate the structure, thus no space is provided as shown in the cross-sectional view in FIG. 11B. Here, the ground conductor 12 provided on the surface side of the substrate 11 and the back surface side of the substrate 14 are bonded together by an insulating adhesive sheet (bonding sheet) 16. FIG. 11C shows the case where the thickness t₂ of the substrate 14 is 0.76 mm and the radiation performance is 37%, 47%, 55%, 59%, and 100% (see FIG. 7) and the case where the thickness t₂ of the substrate 14 is 1 mm and the radiation performance is 100%. As shown in FIG. 7, the radiation performance (%) for the substrate 14 with thickness t₂ of 0.76 mm corresponds to the antenna element 20 in FIGS. 5A and 5B. 37% corresponds to the antenna elements 20-1U and 20-1D, 47% corresponds to the antenna elements 20-2U and 20-2D, 55% corresponds to the antenna elements 20-3U and 20-3D, 59% corresponds to the antenna elements 20-4U and 20-4D, and 100% corresponds to the antenna elements 20-5U and 20-5D.

As shown in FIG. 11C, when the thickness t₂ of the substrate 14 is 0.76 mm, at the low frequency side (27 GHz side) and at the high frequency side (30 GHz side) across 28.5 GHZ, S11 increases as the radiation performance increases from 37% to 100%. When configuring a broadband array antenna, it is preferable to have a small S11 for each antenna element. The S11 with the radiation performance of 37% has a small S11 over the entire frequency range of 27 GHz to 30 GHz. However, the S11 with the radiation performance of 47%, 55%, 59%, and 100% has smaller radiation performance compared to 37% in the vicinity of 28.5 GHZ of the design frequency, while having larger radiation performance compared to 37% at the low frequency side (27 GHz side) and at the high frequency side (30 GHz side). Therefore, as shown in FIG. 8B, S11 of the array antenna 2 is larger compared to the array antenna 1 at the low frequency side (27 GHz side) and at the high frequency side (30 GHz side).

s shown in FIG. 11C, when the thickness t₂ of the substrate 14 is 1 mm, S11 is smaller than the case where the thickness t₂ of the substrate 14 is 0.76 mm, even though the radiation performance is 100%. This is because a volume V between the feeding element 13 and the parasitic element part 25, shown in FIG. 11B by a dash-dot line, is different. In other words, the volume V is larger and the bandwidth is wider in the case where the thickness t₂ of the substrate 14 is 1 mm than the case where the thickness t₂ of the substrate 14 is 0.76 mm. Although we refer to the volume V here for convenience, the volume V is not the product obtained by the area of the parasitic element part 25 (parasitic element) and the thickness of the dielectric material (dielectric) between the feeding element 13 and the parasitic element part 25. In other words, the volume V is a quantity obtained by considering the electric field strength between the feeding element 13 and the parasitic element part 25 (parasitic element). The volume V may be described as volume or capacity.

Generally, array antennas use antenna elements with the same configuration. Such an antenna element has one parasitic element (parasitic element part) provided to face the feeding element. The reflection characteristics of the antenna element are determined by the volume V between the feeding element and the parasitic element, as described above. Different radiation performance (see FIG. 4A) requires different appropriate volume V. If the thickness t₂ of the substrate 14 is chosen to match the antenna element that requires a small volume V, it is required to increase volume V for the antenna element that requires a large volume V. In this case, either the area of the parasitic element is increased or the thickness t₂ of the substrate 14 is increased. However, the area of the parasitic element is limited by the excitation conditions in the parasitic element. Therefore, it is not easy to increase the area of the parasitic element to correspond to the required volume V. On the other hand, if the thickness t₂ of the substrate 14 in the part of the antenna element where a wide bandwidth is required is different from the other parts, the manufacturing of the substrate 14 becomes complicated.

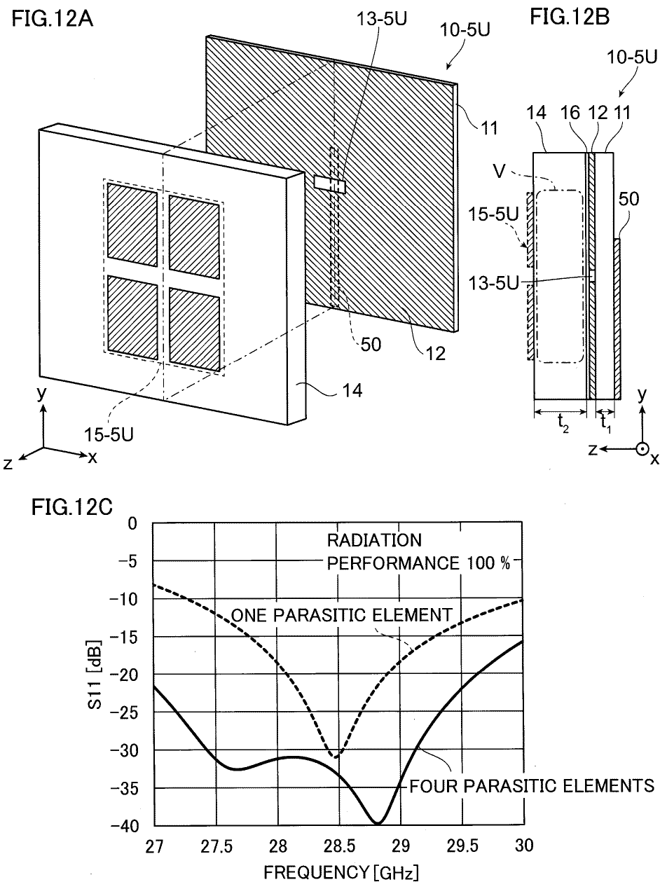

FIGS. 12A to 12C illustrate the reflection characteristic in an antenna element 10 with four parasitic elements in the parasitic element part 15. FIG. 12A is a perspective view of the antenna element 10, FIG. 12B is a cross-sectional view of the area surrounded by a dash-dot line in FIG. 12A, and FIG. 12C is the reflection characteristic when the radiation performance is 100%. Here, the antenna element 10-5U shown in FIGS. 3A and 3B will be explained. The x, y, and z directions in FIG. 12A and FIG. 12B are the same as in FIG. 11A and FIG. 11B, and the horizontal and vertical axes in FIG. 12C are the same as in FIG. 11C. In FIG. 12B, the parasitic element parts 15 that are not included in the area surrounded by a dash-dot line in FIG. 12A are indicated by dashed lines. FIG. 12C also shows the case in which the radiation performance of the antenna element 20 with one parasitic element part 25 is 100% (corresponding to the antenna element 20-5U in FIG. 5).

In the perspective view in FIG. 12A, a space is shown between the ground conductor 12 on the surface side of the substrate 11 and the substrate 14 on which the parasitic element part 15 is provided, however, this is to illustrate the structure, thus no space is provided as shown in the cross-sectional view in FIG. 12B. Here, the ground conductor 12 provided on the surface side of the substrate 11 and the back surface side of the substrate 14 are bonded together by an insulating adhesive sheet (bonding sheet) 16. The thickness t₂ of the substrate 14 is 0.76 mm.

As shown in FIG. 12C, the antenna element 10-5U with four parasitic elements (denoted as 4 parasitic elements) has a smaller S11 in the frequency band from 27 GHz to 30 GHz than the antenna element 20 with one parasitic element (denoted as 1 parasitic element). This is due to the fact that the antenna element 10-5U with four parasitic elements has a larger volume V between the feeding element 13 and the parasitic element part 15-5U than the antenna element 20 with one parasitic element (the antenna element 20-5U). Therefore, it is not necessary to increase the thickness t₂ of the substrate 14 in order to increase the volume V to achieve a wider bandwidth. In other words, the thickness t₂ of the substrate 14 is not changed for the antenna element 10 and can remain constant. In other words, the substrate 14 may have a flat surface. This facilitates the manufacture of the array antenna 1 with the plural antenna elements 10.

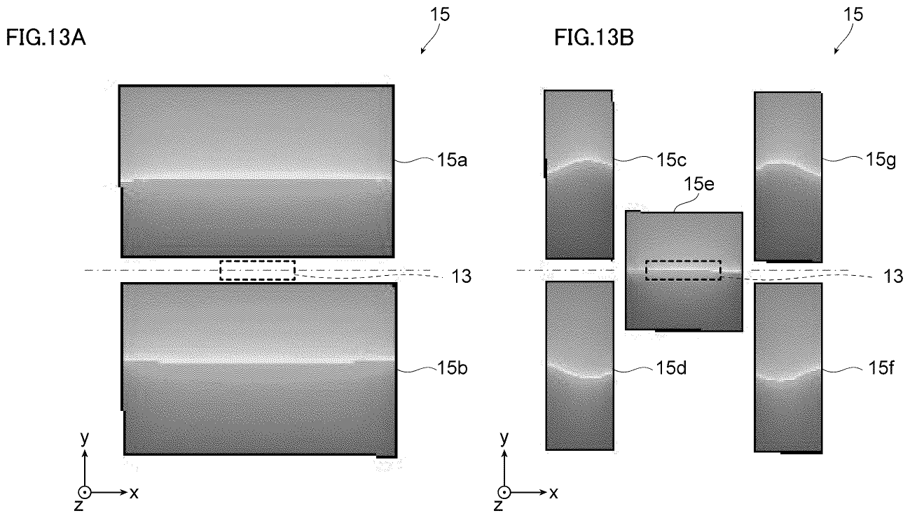

FIGS. 13A and 13B illustrate the electric field distribution in a parasitic element part 15 with multiple parasitic elements. FIG. 13A is the case of two parasitic elements, and FIG. 13B is the case of five parasitic elements. In both FIGS. 13A and 13B, the right direction of the paper surface is referred to as the x direction, the top direction of the paper surface is referred to as y direction, and the front surface direction of the paper surface is referred to as z direction. The color shading indicates the voltage distribution.

The parasitic element part 15 shown in FIG. 13A has two parasitic elements 15a and 15b. The y direction is the electric field (E) direction and the x direction is the magnetic field (H) direction. The two parasitic elements 15a and 15b are separately provided with the H-plane (x-z plane) in a center in the y direction of the feeding element 13 indicated by dashed lines as a border. In FIG. 13A, the line where the H-plane intersects the x-y plane is shown as a dash-dot line. The two parasitic elements 15a and 15b are set to be excited only in a basic mode.

The center of each of the parasitic elements 15a and 15b in the y direction is a voltage node, the end of the +y direction is a +(or −) voltage antinode, and the end of the −y direction is a − (or +) voltage antinode. The parasitic elements 15a and 15b are excited in-phase. In other words, the length of the y direction (E direction) of the parasitic elements 15a and 15b is set to an excitation condition of the basic mode, approximately ½ wavelength. However, the length of the y direction (E direction) of the parasitic elements 15a and 15b is set slightly shorter than ½ wavelength due to the shortening effect. On the other hand, though the width in the x direction (H direction) is arbitrary, if it is too wide, a higher-order mode occurs and the directivity will deteriorate. Its upper limit is the same as that for the case where one parasitic element is used. Therefore, the maximum area of the parasitic element that can be set when the parasitic element part 15 has two parasitic elements is twice the maximum value when the parasitic element part 15 has one parasitic element. The above wavelength is the wavelength of electromagnetic waves in the dielectric (effective wavelength), which is the value obtained by dividing the wavelength in free space by the square root of the relative permittivity of the dielectric (effective wavelength=wavelength in free space/\sqrt{ } relative permittivity).

When the parasitic elements 15a and 15b which are separated at the central H-plane in the y direction of the feeding element 13 and excited in-phase only in the basic mode are provided, the area of the parasitic elements in the parasitic element part 15 (total area) becomes larger compared to the case of one parasitic element without loss of radiation characteristics. Therefore, the volume V (see FIGS. 12A to 12C) between the feeding element 13 and the parasitic element part 15 with two parasitic elements 15a and 15b becomes larger compared to the case of providing one parasitic element.

The parasitic element part 15 shown in FIG. 13B has five parasitic elements 15c, 15d, 15e, 15f, and 15g. Again, the y direction is the electric field (E) direction and the x direction is the magnetic field (H) direction. The parasitic elements 15c and 15d are separately provided with the H-plane in the center in the y direction of the feeding element 13 indicated by dashed lines as a border. Similarly, the parasitic elements 15f and 15g are separately provided with the H-plane in the center in the y direction of the feeding element 13 indicated by dashed lines as a border.

Each of the parasitic elements 15c, 15d, 15f, and 15g is set to be excited in-phase only in a basic mode. On the other hand, the parasitic element 15e is not separately provided by the H-plane. However, the parasitic elements 15e is set to be excited only in a basic mode. In this way, in addition to the parasitic elements 15c, 15d, 15f, and 15g which are separated by the H-plane and excited only in a basic mode, the parasitic element 15e which is not separated by the H-plane and excited only in a basic mode may be provided. The upper limit of the total width in the x direction (H direction) is set close to the upper limit of the width when using one parasitic element. Even in this case, the area (total) of the parasitic elements in the parasitic element part 15 becomes larger compared to the case of one parasitic element without loss of radiation characteristics, and the volume V (see FIG. 12) between the feeding element 13 and the parasitic element part 15 becomes larger. The adjustment range of the volume can be expanded by providing the parasitic element 15e that is not separated by the H-plane. Here, the number of parasitic elements that the parasitic element part 15 has may be other values, such as seven.

In FIGS. 13A and 13B, the plural parasitic elements of the parasitic element part 15 are provided symmetrically in the x direction. When the direction of radio wave radiation is inclined (tilted) from the z direction in the x-z plane, the plural parasitic elements of the parasitic element part 15 may be provided asymmetrically in the x direction. Similarly, the plural parasitic elements of the parasitic element part 15 are provided symmetrically in the y direction. When the direction of radio wave radiation is inclined (tilted) from the z direction in the y-z plane, the plural parasitic elements of the parasitic element part 15 may be provided asymmetrically in the y direction.

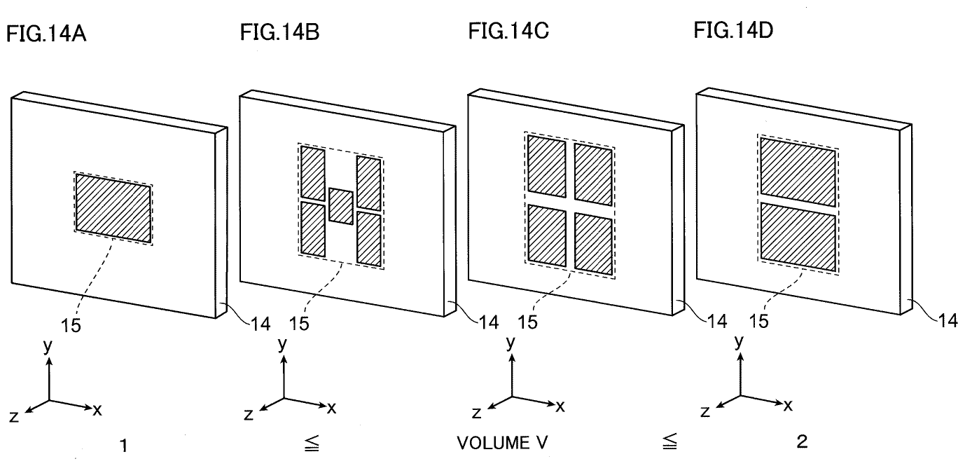

FIGS. 14A to 14D illustrate parasitic element parts 15. FIG. 14A is the case of one parasitic element, FIG. 14B is the case of five parasitic elements, FIG. 14C is the case of four parasitic elements, and FIG. 14D is the case of two parasitic elements.

When the volume V between the parasitic element part 15 and the feeding element 13 in the case of one parasitic element shown in FIG. 14A is 1, the volume V in the case of two parasitic elements in FIG. 14D is approximately double. The volume V increases in the following order: from the case with one parasitic element in FIG. 14A, to the case with five parasitic elements in FIG. 14B, to the case with four parasitic elements in FIG. 14C, and to the case with two parasitic elements in FIG. 14D. Therefore, since the parasitic element part 15 has plural parasitic elements separated by the H-plane, the volume V between the feeding element 13 and the parasitic element part 15 can be set in the range of 1 time (with one parasitic element) to 2 times (with 2 parasitic elements).

The volume V is proportional to the thickness t₂ of the substrate 14. From this, if the thickness to of the substrate 14 which is appropriate to the antenna element 10 with one parasitic element in the parasitic element part 15 is calculated, a substrate 14 in the range of t₀/2<t₂<t₀ can be chosen when the thickness of the substrate 14 is t₂. In other words, broader variety of choice in the thickness t₂ leads to choice of the substrate 14 with thickness t₂, which is easier to obtain.

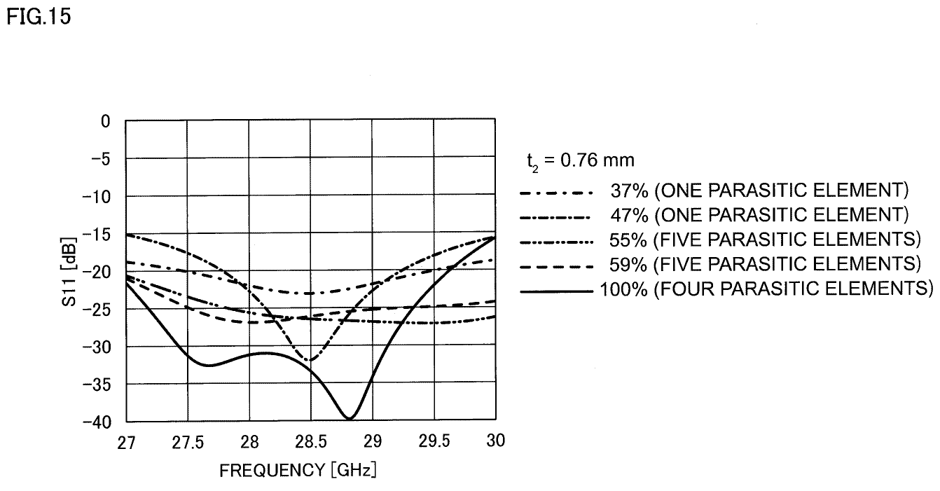

FIG. 15 illustrates the reflection characteristics of the antenna elements 10 provided by the array antenna 1 to which the exemplary embodiment is applied. The horizontal and vertical axes are the same as in FIG. 11C. The substrate 14 has a thickness t₂ of 0.76 mm and a relative permittivity of 3.3. FIG. 15 shows the cases with radiation performance (%) of 37%, 47%, 55%, 59%, and 100%. These radiation performances (%) correspond to the antenna elements 10 in FIG. 7A to FIG. 3. 37% corresponds to the antenna elements 10-1U and 10-1D with one parasitic element (1 parasitic element), 47% corresponds to the antenna elements 10-2U and 10-2D with one parasitic element (1 parasitic element), 55% corresponds to the antenna elements 10-3U and 10-3D with five parasitic elements (5 parasitic elements), 59% corresponds to the antenna elements 10-4U and 10-4D with five parasitic elements (5 parasitic elements), and 100% corresponds to the antenna elements 10-5U and 10-5D with four parasitic elements (4 parasitic elements).

As shown in FIG. 15, the antenna elements 10 with 55%, 59%, and 100% radiation performance have plural parasitic elements in the parasitic element part 15. Therefore, as explained in FIG. 12A, S11 of these antenna elements 10 is smaller than S11 of the antenna element 20 in the parasitic element part 25 with one parasitic element shown in FIG. 11B. Therefore, as shown in FIG. 8B, S11 of the array antenna 1 is smaller than S11 of the array antenna 2.

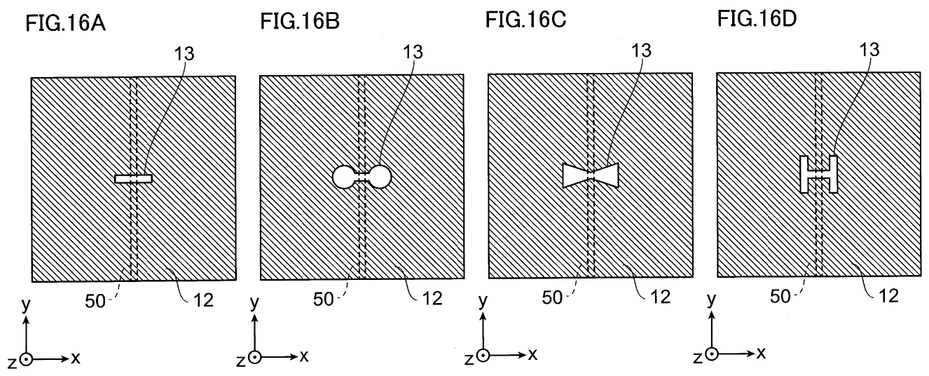

FIGS. 16A to 16D illustrate the shape of the feeding elements (slots) 13. FIG. 16A shows a rectangular shape, FIG. 16B shows a dumbbell shape, FIG. 16C shows a bow-tie shape, and FIG. 16D shows an H-shaped shape.

In the array antenna 1 shown in FIGS. 3A and 3B, the shape and dimensions of the feeding elements (slots) 13, the number of parasitic elements in the parasitic element part 15, and the shape of the feeding lines 50 are set according to the radiation power and radiation performance of the antenna element 10 shown in FIG. 7A. Therefore, the shapes shown in FIGS. 16A to 16D may be used as the shapes of the feeding elements (slots) 13.

### (Antenna Element 10 Radiating Other Polarization)

In the above, the antenna element 10 with vertically polarized wave whose electric field direction is oriented in the array direction (the y direction in FIGS. 3A and 3B) is described. Here, in the array antenna 1 with the feeding line 50 provided in the array direction, an antenna element 10A with a polarization tilted 45-degree from the array direction (denoted as 45-degree polarization) and an antenna element 10B with a polarization tilted 90-degree from the array direction (denoted as horizontal polarization) are described.

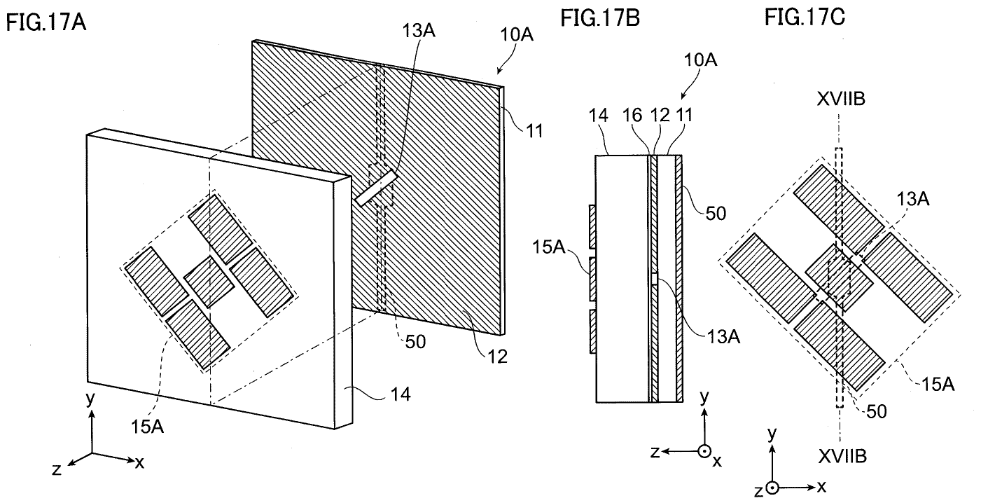

FIGS. 17A to 17C illustrate the antenna element 10A with 45-degree polarization to which the exemplary embodiment is applied. FIG. 17A is a perspective view of the antenna element 10A, FIG. 17B is a cross-sectional view of the area surrounded by a dash-dot line in FIG. 17A and also a cross-sectional view of the XVIIB-XVIIB line in FIG. 17C, and FIG. 17C is a plan view from a parasitic element part 15A. The x, y, and z directions in FIG. 17A and FIG. 17B are the same as in FIG. 11A and FIG. 11B. In FIG. 17C, the right direction of the paper surface is referred to as the x direction, the top direction of the paper surface is referred to as y direction, and the front surface direction of the paper surface is referred to as z direction.

The antenna element 10A has a substrate 11, a ground conductor 12, a feeding element 13A, a substrate 14, and a parasitic element part 15A. The substrate 11, the ground conductor 12, and the substrate 14 are the same as those of antenna element 10, so the same symbols are used and the description is omitted. The feeding line 50 is the same as the feeding line 50 described in FIG. 11. In the perspective view in FIG. 17A, a space is shown between the substrate 11 on which the ground conductor 12 is provided and the substrate 14 on which the parasitic element part 15A is provided, however, this is to illustrate the structure, thus no space is provided as shown in the cross-sectional view in FIG. 17B. The feeding element 13A is provided in contact with the back surface side of the substrate 14 on which the parasitic element part 15A is provided. Here, the ground conductor 12 provided on the surface side of the substrate 11 and the back surface side of the substrate 14 are bonded together by an insulating adhesive sheet (bonding sheet) 16. As a result, the feeding element 13A and the parasitic element part 15A face each other across the substrate 14. In other words, the feeding element 13-1U is provided in contact with surface side of the substrate 14 on which the parasitic element part 15-1U is provided. The parasitic element part 15A is assumed to have five parasitic elements as shown in FIG. 14B, however, the parasitic element part 15A may be provided with other numbers of parasitic elements.

In the antenna element 10A with 45-degree polarization shown in FIGS. 17A and 17C, the feeding element 13A is a rectangular type slot with a longitudinal direction of 45-degree clockwise from the array direction (+y direction). The parasitic element part 15A is the parasitic element part 15 of FIG. 14B rotated 45-degree counterclockwise from the array direction (+y direction). When the antenna element 10A is used instead of the antenna element 10, the array antenna 1 radiates 45-degree polarization tilted 45-degree counterclockwise from the array direction (+y direction).

As shown in FIG. 17C, in the antenna element 10A as well as in the antenna element 10, the feeding line 50 is arranged to overlap the parasitic element part 15A in plan view. Therefore, when plural array antennas 1 in which the antenna element 10A is arranged instead of the antenna element 10 are arranged in parallel, the pitch between the array antennas 1 (pitch P1 in FIG. 2A) does not need to be increased and can be reduced. Therefore, an antenna with the plural array antennas 1 arranged in parallel (similar to the planar antenna 100 in FIG. 1A) can be made smaller.

When feeding the array antenna 1 using the antenna element 10A with 45-degree polarization by central feeding, it is preferable that the phases are differentiated in the array direction and the reverse array direction from each other by 180 degrees from the center of the array direction.

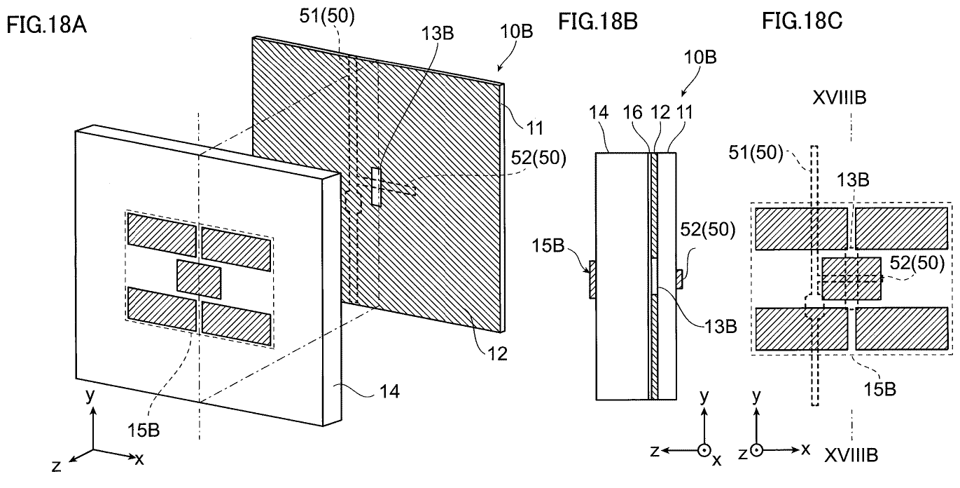

FIGS. 18A to 18C illustrate an antenna element 10B with horizontal polarization to which the exemplary embodiment is applied. FIG. 18A is a perspective view of the antenna element 10B, FIG. 18B is a cross-sectional view of the area surrounded by a dash-dot line in FIG. 18A and also a cross-sectional view of the XVIIIB-XVIIIB line in FIG. 18C, and FIG. 18C is a plan view from the parasitic element part 15B. The x, y, and z directions in FIGS. 18A, 18B, and 18C are the same as in FIGS. 17A, 17B, and 17C.

The antenna element 10B has a substrate 11, a ground conductor 12, a feeding element 13B, a substrate 14, and a parasitic element part 15B. The substrate 11, the ground conductor 12, and the substrate 14 are the same as those of antenna element 10, so the same symbols are used and the description is omitted. In the perspective view in FIG. 18A, a space is shown between the substrate 11 on which the ground conductor 12 is provided and the substrate 14 on which the parasitic element part 15B is provided, however, this is to illustrate the structure, thus no space is provided as shown in the cross section in FIG. 18B. Here, the ground conductor 12 provided on the surface side of the substrate 11 and the back surface side of the substrate 14 are bonded together by an insulating adhesive sheet (bonding sheet) 16. As a result, the feeding element 13B and the parasitic element part 15B face each other across the substrate 14. In other words, the feeding element 13B is provided in contact with the back surface side of the substrate 14 on which the parasitic element part 15B is provided. The parasitic element part 15B is assumed to have five parasitic elements as shown in FIG. 14B, but the parasitic element part 15B may be provided with other numbers of parasitic elements.

As shown in FIGS. 18A and 18C, in the antenna element 10B with horizontal polarization, the feeding element 13B is a rectangular type slot with a longitudinal direction of the array direction (+y direction). The parasitic element part 15B is the parasitic element part 15 of FIG. 14B rotated 90-degree clockwise from the array direction (+y direction). The feeding line 50 has a trunk 51 extending in the y direction and a branch 52 branching in the x direction from a trunk 51. The trunk 51 is shifted from the feeding element 13B to the −x direction side, and the branch 52 extends in the +x direction so that the branch 52 overlaps the feeding element 13B in plan view. An array antenna 1 radiating horizontal polarization is provided when using this antenna element 10B.

As shown in FIG. 18C, in the antenna element 10B with the horizontal polarization, the feeding line 50 is arranged to overlap the parasitic element part 15B in plan view. Therefore, when the plural array antennas 1 in which the antenna element 10B is used instead of the antenna element 10 are arranged in parallel, the pitch between the array antennas 1 (pitch P1 in FIG. 2A) does not need to be increased and can be reduced. Therefore, an antenna with the plural array antennas 1 arranged in parallel (similar to the planar antenna 100 in FIG. 1A) can be made smaller.

When the array antenna 1 using horizontally polarized antenna element 10B is fed with a central feeding, it is not necessary to differentiate the phases in the array direction in the reverse array direction and in the reverse array direction from the center of the array direction.

### Modification Example 1 of Antenna Element 10

In the antenna element 10, a slot is used as the power feeding element 13. When a slot is used as the feeding element 13, the feeding line 50 may be coplanar (CPW: coplanar wave) type.

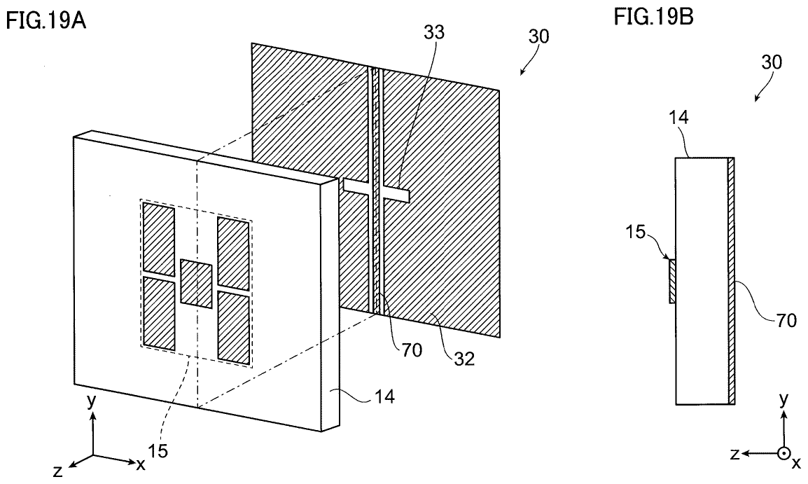

FIGS. 19A and 19B illustrate an example of an antenna element 30 to which a coplanar feeding line 70 is applied, which is a modification example 1 of the exemplary embodiment. FIG. 19A is a perspective view of the antenna element 30, and FIG. 19B is a cross-sectional view of the area surrounded by a dash-dot line in FIG. 19A. The x, y, and z directions in FIG. 19A and FIG. 19B are the same as in FIG. 11A and FIG. 11B.

The antenna element 30 has a substrate 14, a ground conductor 32, a feeding element 33, a substrate 14, and a parasitic element part 15. The substrate 14 and the parasitic element part 15 are the same as those of the antenna element 10, so the same symbols are used and the description is omitted. The parasitic element part 15 is assumed to have five parasitic elements, however, the parasitic element part 15 may be provided with other numbers of parasitic elements.

In the antenna element 30, the parasitic element part 15 is provided on the surface side of the substrate 14, as in the antenna element 10, however, the ground conductor 32 and the feeding element 33 are provided on the back surface side of the substrate 14. The feeding line 70 is also provided on the back surface side of the substrate 14. In the perspective view in FIG. 19A, the ground conductor 32, the feeding element 33, and the feeding line 70 are shown separately from the substrate 14 on which the parasitic element part 15 is provided, however, this is to illustrate the structure, thus the ground conductor 32, feeding element 33 and feeding line 70 are provided on the back surface side of the substrate 14 as shown in the cross-sectional view in FIG. 19B.

The ground conductor 32, the feeding element 33, and the feeding line 70 are formed by conductive materials provided on the back surface side of the substrate 14. In other words, as shown in FIG. 19A, the feeding line 70 is provided at the center of the back surface side of the substrate 14 in the x direction, and the ground conductor 32 is provided at both sides of the substrate 11 in the +x direction across the feeding line 70. The feeding element 33 is an opening (slot) provided by removing the ground conductor 32 as if the feeding element 33 is spread in the +x direction, and is rectangular having a long side in the perpendicular direction (+x direction) to the array direction (+y direction) and a short side in the array direction (+y direction). The feeding line 70 is provided at the center of the opening (slot). The feeding element 33 and the parasitic element part 15 face each other across the substrate 14. In other words, the feeding element (slot) 33 is provided on the back surface side of the substrate 14 on which the parasitic element part 15 is provided.

In the antenna element 30, the ground conductor 32, the feeding element (slot) 33, and the feeding line 70 are composed of one layer of conductive material provided on the back surface side of the substrate 14. Therefore, by using the substrate 14 having layers of conductive material on both sides (front and back surfaces), it is sufficient to provide the parasitic element part 15 on the front surface side and to provide the ground conductor 32, the feeding element (slot) 33, and the feeding line 70 on the back surface side. Therefore, while the antenna element 10 uses the substrate 11 and the substrate 14, the antenna element 30 does not require the substrate 11. In other words, the antenna element 30 has fewer substrates.

In case of the antenna element 30 (corresponding to the antenna elements 10-5U and 10-5D in FIG. 3A), which is placed at the end of the feeding line 70, the feeding line 70 is connected to the ground conductor 32.

As shown in FIGS. 19A and 19B, in the antenna element 30, as in the antenna element 10, the feeding line 70 is arranged to overlap the parasitic element part 15 in plan view. Therefore, when the plural array antennas 1 in which the antenna element 30 is arranged instead of the antenna element 10 are arranged in parallel, the pitch between array antennas 1 (pitch P1 in FIG. 2A) does not need to be increased and can be reduced. Therefore, an antenna with plural array antennas 1 arranged in parallel (similar to the planar antenna 100 in FIG. 1A) can be made smaller.

The array antenna 1 using the antenna element 30 and the feeding line 70 instead of the antenna element 10 and the feeding line 50 radiates polarization (vertical polarization) in the array direction (+y direction).

### Modification Example 2 of Antenna Element 10

Slots are used as the feeding element 13 of the antenna element 10 and the feeding element 33 of the antenna element 30. Patches may also be used as the feeding elements. In the following, the patch is referred to as a feeding element (a patch) 43.

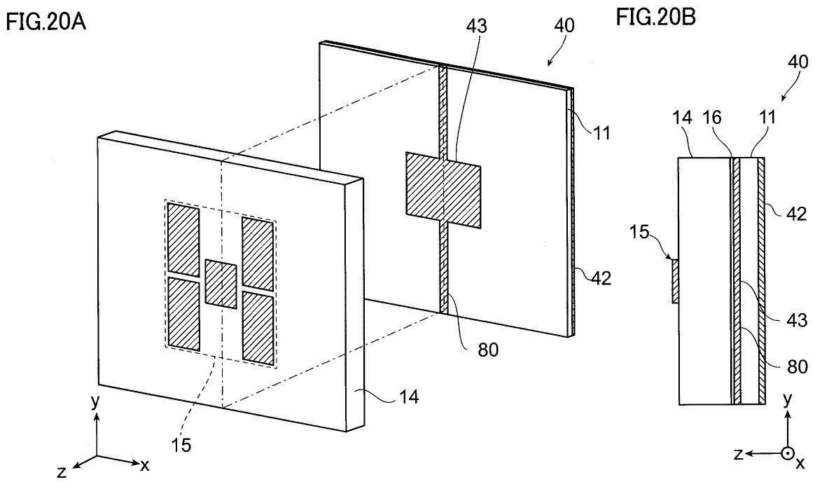

FIGS. 20A and 20B illustrate an example of an antenna element 40 to which a feeding element (a patch) 43 is applied, which is a modification example 2 of the exemplary embodiment. FIG. 20A is a perspective view of the antenna element 40, and FIG. 20B is a cross-sectional view of the area surrounded by a dash-dot line in FIG. 20A. The x, y, and z directions in FIG. 20A and FIG. 20B are the same as in FIG. 11A and FIG. 11B.

The antenna element 40 has a substrate 11, a ground conductor 42, a feeding element (a patch) 43, a substrate 14, and a parasitic element part 15. The substrate 11, the substrate 14, and the parasitic element part 15 are the same as those of the antenna element 10, so the same symbols are used and the description is omitted. In the perspective view in FIG. 20A, a space is shown between the substrate 11 on which the feeding element (the patch) 43 is provided and the substrate 14 on which the parasitic element part 15 is provided, however, this is to illustrate the structure, thus no space is provided as shown in the cross section in FIG. 20B. Here, the feeding element (the patch) 43 provided on the surface side of the substrate 11 and the back surface side of the substrate 14 are bonded together by an insulating adhesive sheet (bonding sheet) 16. The parasitic element part 15 is assumed to have five parasitic elements, however, the parasitic element part 15 may be provided with other numbers of parasitic elements.

The feeding element (the patch) 43 is composed of conductive material on the surface side of the substrate 11. The feeding element (the patch) 43 is a rectangular in shape and faces the parasitic feeding element part 15 provided on the substrate 14. The ground conductor 32 is composed of conductive material on the back surface side of the substrate 11. Here, the ground conductor 32 is provided to cover the entire back surface side of the substrate 11. However, the ground conductor 32 does not necessarily need to cover the entire back surface side of the substrate 11, but only needs to be provided on the back surface side of the substrate 11 so as to face the feeding element (the patch) 43 provided on the front side and to face the feeding line 80 to be described later. The antenna element 40 using the feeding element (the patch) 43 is a microstrip antenna (MSA). The feeding element 43 and the parasitic element part 15 face each other across the substrate 14. In other words, the feeding element 13-1U is provided to be in contact with the back surface side of the substrate 14 on which the parasitic element part 15 is provided. The feeding element (the patch) 43 and the feeding line 80 may be provided on the back surface side of the substrate 14.

The feeding line 80 is composed of conductive material on the surface side of the substrate 11, and is connected to the feeding element (the patch) 43. In other words, the feeding line 80 and the feeding element (the patch) 43 are composed of one layer of conductive material on the surface side of the substrate 11. In FIGS. 20A and 20B, one antenna element 40 is shown, however, in the case of an array antenna with plural antenna elements 40, the feeding line 80 is provided to connect the multiple feeding elements (the patches) 43 in series. The feeding line 80 is terminated at the antenna element 40 which is arranged at the end (corresponding to the antenna elements 10-5U and 10-5D in FIG. 3A).

The array antenna 1 using the antenna element 40 instead of the antenna element 10 radiates a vertical polarization with the electric field oriented in the array direction (+y direction).

As shown in FIGS. 20A and 20B, in the antenna element 40, as in the antenna element 10, the feeding line 80 is arranged to overlap the parasitic element part 15 in plan view. Therefore, when the plural array antennas 1 in which the antenna element 40 is used instead of the antenna element 10 are arranged in parallel, the pitch between the array antennas 1 (pitch P1 in FIG. 2A) does not need to be increased and can be reduced. Therefore, an antenna with plural array antennas 1 arranged in parallel (similar to the planar antenna 100 in FIG. 1A) can be made smaller.

When a patch is used as the feeding element 43, it is difficult to configure an array antenna where a polarized wave tilted at 45 degrees (45-degree polarization) or 90 degrees (horizontal polarization) tilted with respect to the direction in which the feeding line 80 is provided (here, the y direction). This is because, in order to configure an array antenna of 45-degree polarization or an array antenna of horizontal polarization, it is necessary to provide a feeding line branched from the feeding line 80 via an impedance matching circuit or the like to supply power. Therefore, the pitch between adjacent array antennas (pitch P1 in FIG. 2A) may become large. Therefore, when a patch is used for the feeding element 43, it is preferable to use polarization in the direction in which the feeding line 80 is provided.

As explained above, the array antenna 1 to which the exemplary embodiment is applied is described to use a series feeding system in which the antenna elements 10 (in FIGS. 3A and 3B, the antenna elements 10-1U to 10-5U) in the array direction (+y direction) and the antenna elements 10 (in FIGS. 3A and 3B, the antenna elements 10-1D to 10-5D) in the opposite array direction (−y direction) are supplied with power by the central feeding. However, a corner feeding where power is supplied from one end (a corner) in which the antenna elements 10 are arranged may also be used.

In the central feeding, it is sufficient to supply power to half of the number of the antenna elements 10 respectively, and the power supply starts from the antenna element 10 with the large relative radiated power, as shown in FIG. 7. On the other hand, in the corner feeding, power is supplied to all of the antenna elements 10, and the power supply starts from the antenna element 10 with the small relative radiated power.

In the antenna element 10 to which the exemplary embodiment is applied, the planar shape of the parasitic elements included in the parasitic element part 15 is a rectangle, however, the planar shape of the parasitic elements may be a square other than a rectangle, a square without corners, or any other shape such as a circle, oval, or polygon.

As explained above, in the array antenna 1 to which the exemplary embodiment is applied, by differentiating the number of parasitic elements that the parasitic element portion 15 of the antenna element 10 has, the reflection characteristics of the antenna element 10 are controlled. The volume V between the feeding element 13 and the parasitic element part 15 can be adjusted by making the parasitic element part 15 have plural parasitic elements separated by the H-plane at the center of the feeding element 13. Since the parasitic element part 15 has plural parasitic elements, the volume V between the feeding element 13 and the parasitic element part 15 is larger compared to the case where the parasitic element part 15 has one parasitic element. Therefore, the volume V can be increased without increasing the thickness of the substrate 14. The plural parasitic elements are respectively set to be excited in a basic mode. Therefore, while suppressing deterioration of the radiation characteristics of the antenna element 10, the return loss S11 is suppressed, and the antenna element 10 is broad banded.

When the feeding element is a slot (the feeding elements 13, 33) or the feeding element is a patch (the feeding element 43), the feeding lines (the feeding lines 50, 70, 80) are arranged to overlap the parasitic element part 15 of the antenna element (the antenna elements 10, 30, 40) in plan view. In other words, in plan view, the feeding lines overlap the antenna elements. Therefore, when array antennas 1 with multiple antenna elements are arranged in parallel, the pitch between the array antennas 1 (pitch P1 in FIG. 2A) can be reduced. Therefore, an antenna with plural array antennas 1 arranged in parallel (an antenna similar to the planar antenna 100 in FIG. 1A) can be made smaller.

Furthermore, various modifications may be employed as long as not violating the intent of the invention.

### REFERENCE SIGNS LIST

1, 1′, 2 . . . array antenna, 10, 10′, 20, 30, 40 . . . antenna element, 11, 14 . . . substrate, 12, 32, 42 . . . ground conductor, 13, 23, 33, 43 . . . feeding element, 15, 25 . . . parasitic element, 16 . . . adhesive sheet (bonding sheet), 50, 50′, 60, 70, 80 . . . feeding line, 100 . . . planar antenna, 200 . . . control unit, 300 . . . radio waves, G_{E}, G_{H} . . . gap, P1, P2 . . . pitch, V . . . volume, W_{E}, W_{H} . . . width

1. An array antenna comprising:
a first antenna element and a second antenna element configured to transmit and receive radio waves; and
a feeding line configured to feed the first antenna element and the second antenna element in series, wherein
the first antenna element and the second antenna element respectively have a feeding element fed from the feeding line and a parasitic element part having a parasitic element, the parasitic element part being provided to face the feeding element, and
a number of the parasitic element of the parasitic element part in the first antenna element is different from a number of the parasitic element of the parasitic element part in the second antenna element.

2. The array antenna according to claim 1 comprising:
a substrate made of a dielectric material, on whose surface side the parasitic element part in the first antenna element and the parasitic element part of the second antenna element are provided, wherein
the feeding element in the first antenna element and the feeding element of in second antenna element are provided on a back surface side of the substrate or are provided to be in contact with the back surface side of the substrate.

3. The array antenna according to claim 2, wherein the substrate has a constant thickness.

4. The array antenna according to claim 1, wherein at least any one of the parasitic element part in the first antenna element and the parasitic element part in the second antenna element comprises a plurality of parasitic elements including a pair of parasitic elements, a pair of the parasitic elements being separately provided with a H-plane in a center of the feeding element as a border and being excited in-phase in a basic mode.

5. The array antenna according to claim 4, wherein the plurality of parasitic elements includes a parasitic element that is not separately provided with the H-plane as a border.

6. The array antenna according to claim 4, wherein a volume between the plurality of parasitic elements and the feeding element is larger than a volume in a case between one parasitic element and the feeding element.

7. The array antenna according to claim 1, wherein the parasitic element part in the first antenna element and the parasitic element part in the second antenna element overlap the feeding line in plan view.

8. The array antenna according to claim 2 comprising:
an other substrate made of a dielectric material, wherein
the feeding element is provided on a surface side of the other substrate, and
the substrate and the other substrate are stacked with a back surface side of the substrate and a front surface side of the other substrate.

9. The array antenna according to claim 1, wherein the feeding line is a corner feeding where power is supplied from one end of an array in which antenna elements are arranged, or a central feeding where power is supplied from a center of the array in opposite directions to each other.

10. The array antenna according to claim 9, wherein when the feeding line is the central feeding and radiates polarization along an array direction or radiates polarization that is shifted with 45-degree from the array direction, phases of the power supplied from the center in opposite directions to each other are shifted with 180 degrees.

11. The array antenna according to claim 1, wherein the feeding element is a slot or a patch.

12. An antenna element comprising:
a feeding element as a slot; and
a plurality of parasitic elements provided to face the feeding element, wherein
the plurality of parasitic elements include at least a pair of the parasitic elements, the pair of parasitic elements being separately provided with a H-plane in a center of the feeding element as a border and being excited in-phase in a basic mode.

13. The antenna element according to claim 12, wherein the plurality of parasitic elements includes a parasitic element that is not separately provided with the H-plane in the center of the feeding element as a border.

14. The antenna element according to claim 12 comprising:
a substrate on whose surface side the plurality of parasitic elements are provided, wherein
the feeding element is provided on a back surface side of the substrate or provided to be in contact with the back surface side of the substrate.

15. The antenna element according to claim 12 comprising:
an other substrate on whose surface side the feeding element is provided, wherein
the substrate and the other substrate are stacked with a back surface side of the substrate and a front surface side of the other substrate.

16. (canceled)
